(19) United States
(12) Patent Application Publication
(10) Pub. No.: US 2026/0181562 A1
(43) Pub. Date: Jun. 25, 2026

(54) METHODS AND APPARATUS FOR PHYSICAL UPLINK SHARED CHANNEL POWER CONTROL IN CELLULAR NETWORK

(71) Applicant: NTT DOCOMO, INC., Tokyo (JP)

(72) Inventors: David Alejandro Ramirez Dominguez, Sunnyvale, CA (US); Haralabos Papadopoulos, Sunnyvale, CA (US); Fujio Watanabe, Sunnyvale, CA (US)

(21) Appl. No.: 19/423,584

(22) Filed: Dec. 17, 2025

Related U.S. Application Data
(60) Provisional application No. 63/738,137, filed on Dec. 23, 2024.

(51) Int. Cl. H04W 52/32; H04W 72/21; H04W 72/23

(52) U.S. Cl. CPC H04W 52/325; H04W 72/21; H04W 72/23

(57) ABSTRACT

Embodiments provide methods and systems for physical uplink shared channel (PUSCH) power control. A user equipment (UE) may associate with a base station (BS), measure reference signal received power (RSRP) data, report the RSRP data to the BS, receive P_0 and P_UE values from the BS, and transmit signals to the BS using P_TX as defined by a PUSCH. A network may initialize a BS with default power values and default cluster groups per cluster, transmit new power settings to the first BS, collect network data from the first BS, validate requirements, update power allocation among UEs, and validate power allocation among the UEs. UEs may be clustered (grouped) based on measurement data, e.g., their reported RSRP values to the first BS and a neighbor BS.

### RELATED APPLICATION

The present application claims the benefit of U.S. Provisional Patent Application No. 63/738,137, filed on Dec. 23, 2024, and entitled “METHODS AND APPARATUS FOR PHYSICAL UPLINK SHARED CHANNEL POWER CONTROL IN CELLULAR NETWORK”, which is incorporated herein by reference in its entirety.

### FIELD OF DISCLOSURE

This disclosure relates generally to wireless technology and more particularly to techniques for physical uplink shared channel (PUSCH) power control.

### BACKGROUND

A telecommunication network is a system that allows for the exchange of information between entities, or nodes, through links. A cellular network is a type of a telecommunication network where the link to and from end nodes is wireless and the network is distributed over small geographical areas called cells, served by at least one fixed-location transceiver (such as a base station (BS)). BSs provide the cell with the network coverage which can be used for transmission of voice, data, and other types of content via radio waves. Each cell's coverage area is determined by factors such as the power of the transceiver, antenna parameters (antenna height, antenna beamwidth in horizontal and vertical direction, antenna azimuth direction and tilt, available MIMO configuration and capabilities, etc.), the terrain, and the frequency band being used. A user equipment (UE) communicates with the network or the cell through a BS. Interference between different UEs across different BSs may degrade overall system performance. For example, higher transmission power by a UE may be necessary for the UE to communicate with the BS, but may cause more interference with other UEs.

### BRIEF SUMMARY

Processes, machines, and articles of manufacture for physical uplink shared channel (PUSCH) power control are described. In some embodiments, a method of wireless communication by a network for physical uplink shared channel (PUSCH) power control includes performing a power control algorithm for a plurality of iterations until a signal-to-interference-plus-noise ratio (SINR) is within a tolerance level of a target SINR. In some embodiments, each iteration includes, for each cell of a set of one or more cells, obtaining the SINR associated with user equipments (UEs) in said each cell, lowering transmit power of the UEs in said each cell upon determining SINR is above a target SINR, and increasing transmit power upon determining SINR is below the target SINR; and updating a power allocation among UEs in said each cell.

Other processes, machines, and articles of manufacture are also described hereby, which may be combined in any number of ways, such as with the embodiments of the brief summary, without departing from the scope of this disclosure.

### BRIEF DESCRIPTION OF THE DRAWINGS

The present disclosure is illustrated by way of example and not limitation in the figures of the accompanying drawings in which like references indicate similar elements. To easily identify the discussion of any particular element or act, the most significant digit or digits in a reference number refer to the figure number in which that element is first introduced.

FIG. 1 illustrates an example wireless communication system according to some embodiments.

FIG. 2 illustrates a BS or base station (BS) in communication with a user equipment (UE) device according to some embodiments.

FIG. 3 illustrates an example block diagram of a UE according to some embodiments.

FIG. 4 illustrates an example block diagram of a gNB or BS according to some embodiments.

FIG. 5 illustrates an example block diagram of cellular communication circuitry according to some embodiments.

FIG. 6 illustrates an example diagram of open radio access network (O-RAN) architecture according to some embodiments.

FIG. 7 schematically depicts a process of PUSCH power control according to some embodiments.

FIG. 8 schematically depicts a process of PUSCH power control according to some embodiments.

FIG. 9 schematically depicts a process of PUSCH power control according to some embodiments.

FIG. 10 illustrates an example aspect of UE transmissions to BSs for PUSCH power control according to some embodiments.

FIG. 11 illustrates an example table listing (SINR of UE1, SINR of UE2, weighted square distance) for respective reference signal received power (RSRP) of UE1 and UE2 according to some embodiments. “SINR” refers to signal to interference

FIG. 12 illustrates an example table listing (SINR of UE1, SINR of UE2, sum of SINR of UE1 and UE2) for RSRP of UE1 and UE2 according to some embodiments.

FIG. 13 illustrates an example chart of cumulative instance (%) for SINR according to some embodiments.

FIG. 14 illustrates an example aspect of RSRP from a UE to a neighbor base station (BS) (“neigRSRP”) and RSRP from a UE to a serving BS (servRSRP) for PUSCH power control according to some embodiments.

FIG. 15 illustrates an example modulation and coding scheme (MCS) index table according to some embodiments.

FIG. 16 illustrates an example aspect of the UEs and BSs according to some embodiments.

FIG. 17 illustrates an example aspect of clustering of the UEs according to some embodiment.

FIG. 18 illustrates some embodiments of a process for a method of wireless communication by a UE for PUSCH power control.

FIG. 19 illustrates some embodiments of a process for wireless communication by a BS for PUSCH power control.

FIG. 20 illustrates some embodiments of a process for wireless communication by a network for PUSCH power control.

FIG. 21 illustrates some embodiments of a process for initializing values (for example as described in FIG. 20).

FIG. 22 illustrates some embodiments of a process for validating requirements (for example as described in FIG. 20).

FIG. 23 illustrates some embodiments of a process for breaking up clusters (for example as described in FIG. 22).

FIGS. 24A and 24B schematically depict an example aspect for breaking up clusters (for example as described in FIG. 22).

FIG. 25 illustrates some embodiments of a process for updating power allocation (for example as described in FIG. 20).

FIG. 26 illustrates some embodiments of a process for validating power allocation (for example as described in FIG. 20).

FIG. 27 illustrates an example diagram of the relationship between diversity in power (P) among UEs or BSs and performance.

FIG. 28 illustrates some embodiments of a process for wireless communication by a UE for PUSCH power control.

FIG. 29 illustrates some embodiments of a process for wireless communication by a BS for PUSCH power control.

FIG. 30 illustrates some embodiments of a process for wireless communication by a network for PUSCH power control.

### DETAILED DESCRIPTION

Generally, this disclosure describes techniques for controlling the transmit power of UEs in the network in order to improve the overall performance in uplink communication of a cellular network. More specifically, embodiments are directed to techniques to control transmit power after scheduling UE's into resource bins (RBs) determined by the scheduler. Techniques disclosed herein aim to control the transmission powers of scheduled UEs so that the overall interference caused by scheduled UEs (to one another) are controlled towards achieving a minimum target performance for each UE.

In the following description, numerous specific details are set forth to provide thorough explanation of embodiments of the present disclosure. It will be apparent, however, to one skilled in the art, that embodiments of the present disclosure may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the disclosure. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” may be used to indicate that two or more elements, which may or may not be in direct physical or electrical contact with each other, co-operate or interact with each other. “Connected” may be used to indicate the establishment of communication between two or more elements that are coupled with each other.

The processes depicted in the figures that follow, are performed by processing logic that comprises hardware (e.g., circuitry, dedicated logic, et cetera), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

“PUSCH” as used herein refers to a channel used for uplink (i.e., from UE to BS) transmission of data. “Power control” as used herein refers to controlling the UE's transmission power. “Signal to interference and noise ratio” or “SINR” as used herein refers to (signal power)-(interference and noise power). “Signal to noise ratio” or “SNR” as used herein refers to (signal power)-(noise power). SINR or SNR may be measured in dB.

In some embodiments, a method of wireless communication by a UE for PUSCH power control includes measuring reference signal received power (RSRP) data; reporting the RSRP data to the first BS; receiving P_0 and P_UE values from the first BS; and transmitting signals to the BS using P_TX as defined by a PUSCH. P_0 (=P₀) is nominal power and is a cell-specific parameter. P_UE (=P_{UE}) is a UE-specific parameter. So, all UEs served by the same cell will use the same P_0 value but can have distinct P_UE values. In some embodiments, the UE uses both values, along with other parameters, to define the PUSCH transmit power.

In some embodiments, a method of wireless communication by a BS for PUSCH power control includes associating with a first base station (BS); receiving a lookup table from a network; collecting reference signal received power (RSRP) data from a user equipment (UE); based on the RSRP data, identifying a cluster to which the UE belongs; based on the lookup table, identifying a P_UE value for the UE, wherein P_UE is a power parameter of the specific UE; reporting the P_UE value to the UE; collecting signal power minus interference and noise power (SINR) data from the UE; and reporting the RSRP data and the SINR data to the network.

In some embodiments, a method for wireless communication by a network for PUSCH power control includes initializing a base station (BS) with default cluster groups and default power values per cluster; transmitting new power settings to the BS; collecting network data from the BS; validating requirements; updating power allocation among user equipments (UEs); and validating power allocation among the UEs.

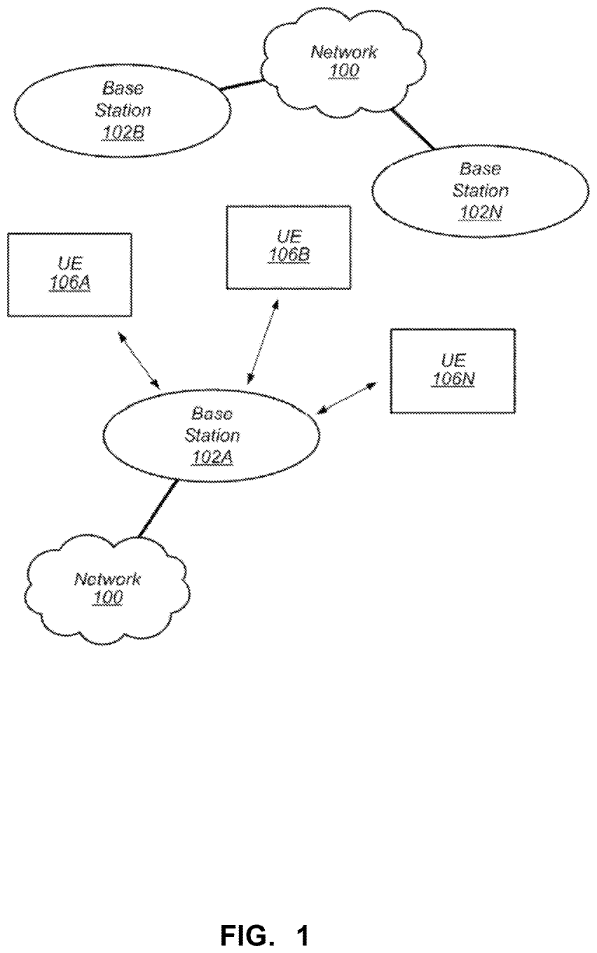

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, et cetera, through 106N. Each of the user devices may be referred to herein as a “user equipment” (UE) or UE device. Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), 6G, et cetera. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’. A next generation eNB (ng-eNB) may comprise an enhanced version of eNB that connects 5G UE to 5G core network using 4G LTE air interface.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services. It will be appreciated that in various embodiments, the term “network” may be utilized to collectively refer to one or more devices and components that form the telecommunications network. For example, reference to the network sending or receiving data to/from a UE may refer to one or more portions of the core network of a cellular service provider and/or one or more base stations. In some such examples, data to send to the UE may be determined by core network components and then relayed to the UE via a base station. In other such examples, data to send to the UE may be determined and sent to the UE by a base station.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a BS may be connected to a legacy evolved packet core (EPC) network and/or to a NR core (NRC) network. In addition, a BS cell may include one or more transition and reception points (TRPs). In addition, a UE capable of operating according to 5G NR may be connected to one or more TRPs within one or more BSs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, 6G, HSPA, 3GPP2 CDMA2000 (e.g., 1×RTT, 1×EV-DO, HRPD, eHRPD), et cetera). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

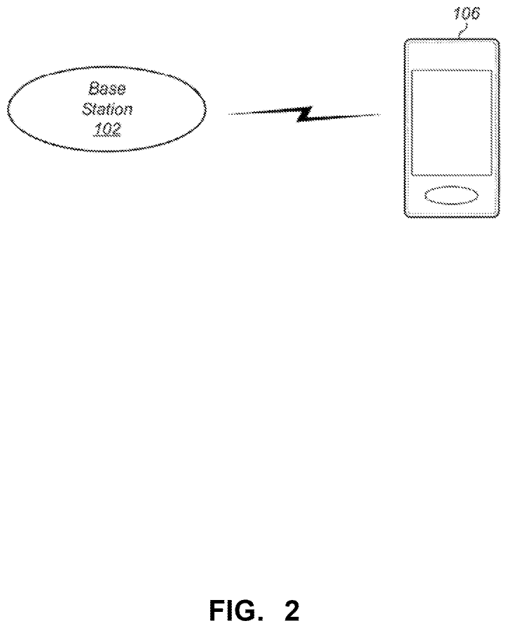

FIG. 2 illustrates user equipment 106 (e.g., one of the devices 106A through 106N) in communication with a base station 102, according to some embodiments. The UE 106 may be a device with cellular communication capability such as, for example, a mobile phone, a hand-held device, a computer or a tablet, or virtually any type of wireless device.

The UE 106 may include a processor that is configured to execute program instructions stored in memory. The UE 106 may perform any of the functions and/or operations described herein by executing such stored instructions. Alternatively, or in addition, the UE 106 may include a programmable hardware element such as an FPGA (field-programmable gate array) that is configured to perform any of the embodiments described herein, or any portion of any of the embodiments described herein.

The UE 106 may include one or more antennas for communicating using one or more wireless communication protocols or technologies. In some embodiments, the UE 106 may be configured to communicate using, for example, 5G NR, CDMA2000 (1×RTT/1×EV-DO/HRPD/eHRPD), 6G, or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM or 6G), and separate radios for communicating using each of Wi-Fi and Bluetooth. Other configurations are also possible.

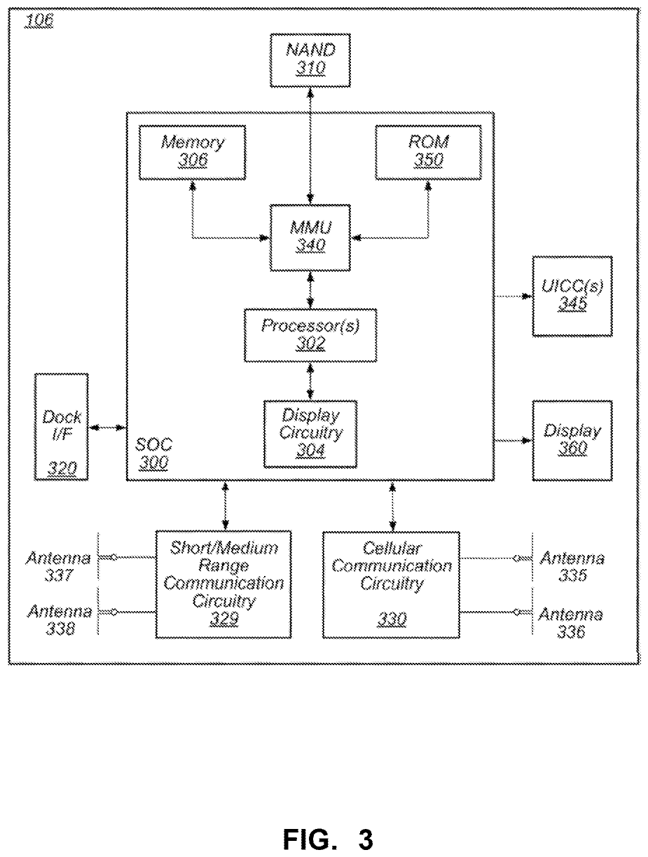

FIG. 3 illustrates some embodiments of an example simplified block diagram of a UE 106 (or other communication device). It is noted that the block diagram of the communication device of FIG. 3 is only one example of a possible communication device. In some embodiments, UE 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the UE 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the UE 106.

For example, the UE 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the UE 106, and cellular communication circuitry 330 such as for 5G NR, LTE, GSM, etc., and short to medium range wireless communication circuitry 329 (e.g., Bluetooth™ and WLAN circuitry). In some embodiments, UE 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly, dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The UE 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The UE 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the UE 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the UE 106 may be configured to communicate using wireless and/or wired communication circuitry. The UE 106 may be configured to transmit a request to attach to a first network node operating according to the first RAT (e.g., 5G NR, 4G LTE, Bluetooth, Wi-Fi, et cetera) and transmit an indication that the wireless device is capable of maintaining substantially concurrent connections with the first network node and a second network node that operates according to the second RAT (e.g., 5G NR, 4G LTE, Bluetooth, Wi-Fi, et cetera). The wireless device may also be configured transmit a request to attach to the second network node. The request may include an indication that the wireless device is capable of maintaining substantially concurrent connections with the first and second network nodes. Further, the wireless device may be configured to receive an indication that dual connectivity with the first and second network nodes has been established.

As described herein, the UE 106 may include hardware and software components for implementing the above features for supporting DGL transmissions. The processor 302 of the UE 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the UE 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, et cetera) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, et cetera) configured to perform the functions of cellular communication circuitry 330. Similarly, the short range wireless communication circuitry 329 may include one or more ICs that are configured to perform the functions of short range wireless communication circuitry 329. In addition, each integrated circuit may include circuitry (e.g., first circuitry, second circuitry, et cetera) configured to perform the functions of short range wireless communication circuitry 329.

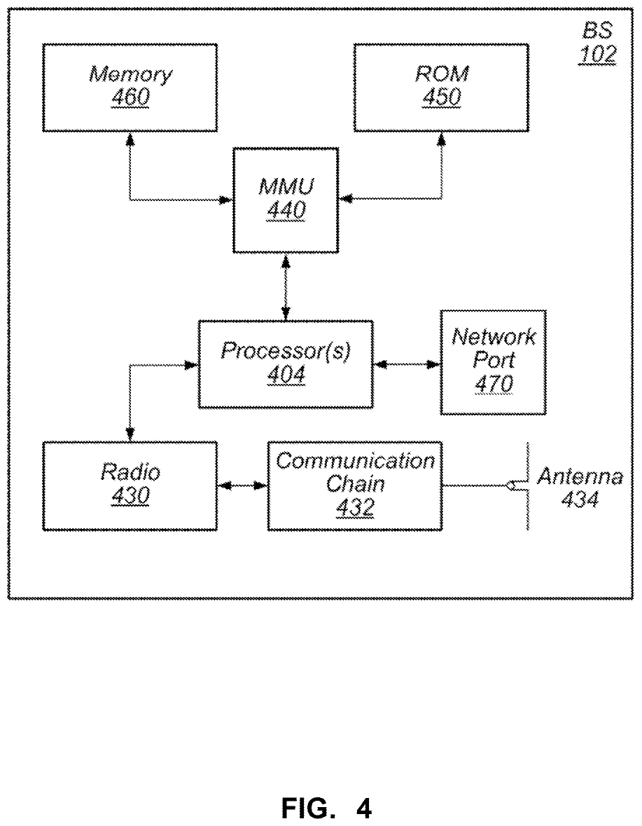

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “next generation Node B,” “gNodeB,” “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas, such as an array of antennas. These antenna may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

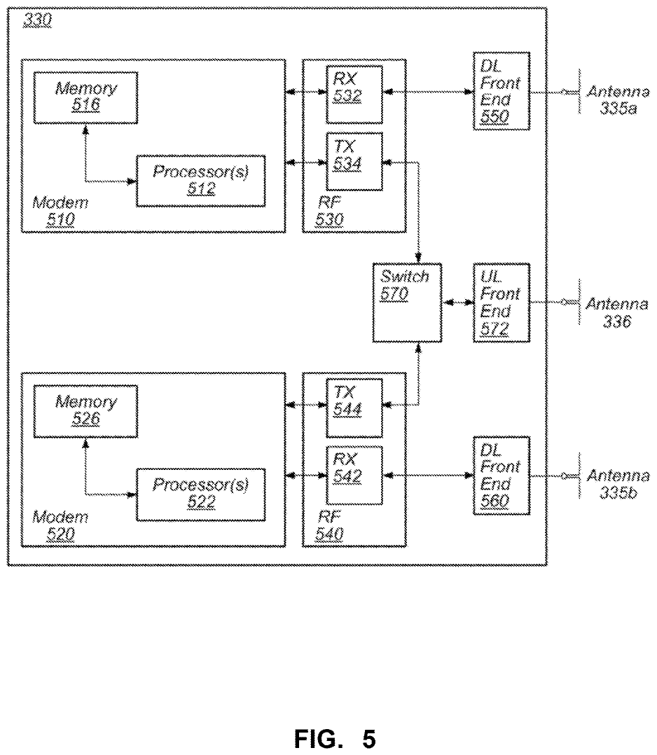

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 330 can be included in a communication device, such as UE 106 described above. Additionally or alternatively, instead of a UE, the communication device can be a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown. In some embodiments, cellular communication circuitry 330 may include dedicated receive chains (including and/or coupled to, e.g., communicatively; directly or indirectly, dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for supporting DGL transmissions, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, et cetera) configured to perform the functions of processors 512.

As described herein, the modem 520 may include hardware and software components for implementing the above features for supporting DGL transmissions, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, et cetera) configured to perform the functions of processors 522.

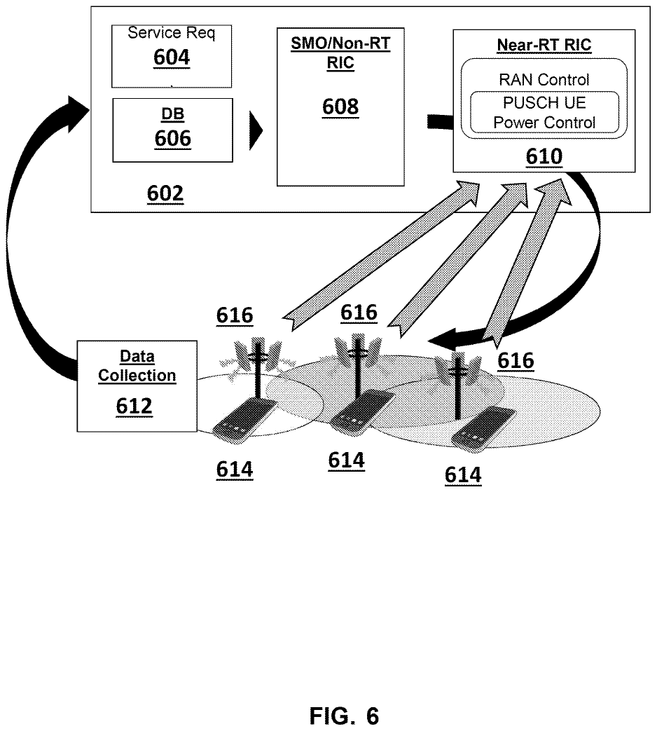

FIG. 6 illustrates an example diagram of open radio access network (O-RAN) architecture. O-RAN 602 includes database (DB) 606 with service requirements 604, service management and orchestration/non-real time RAN intelligent controller (SMO/non-RT RIC) 608, and near-RT RIC 610. DB 606 contains and controls network log/network traffic and BS (e.g., gNodeB (gNB)) information. SMO/non-RT RIC 608 conducts control policy optimization, parameter optimization, and executes parameter plan. Near-RT RIC 610 conducts RAN control and PUSCH UE power control.

SMO/non-RT RIC 608 or near-RT RIC 610 transmits signals to BS 616. UE 614 associates with BS 616. BS 616 transmits data for near RT-RIC 610. BS 616 also collects data 612, such as terminal report and gNB report and transmits the data to DB 606.

As used herein, E-UTRAN cell identity (ECI) refers to a unique identifier assigned to each individual cell within an LTE network, composed of the eNodeB ID and the physical cell ID, acting as a cell ID that allows mobile devices to identify and connect to a specific BS (cell tower) for communication. In some embodiments provided herein, a BS may be an ECI. In some embodiments, an ECI may refer to a BS.

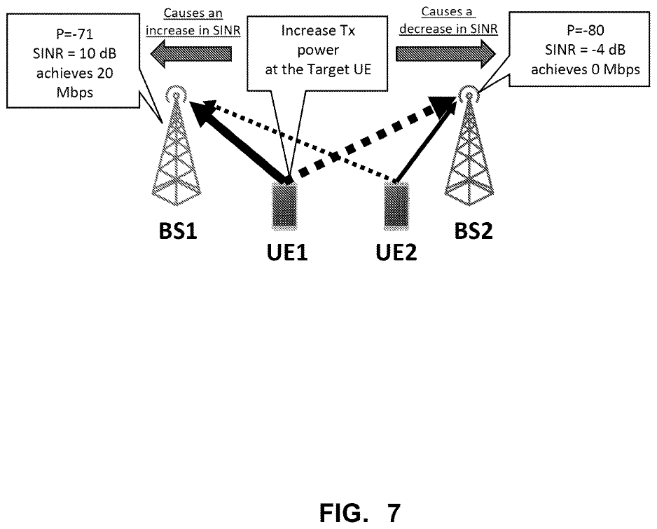

FIGS. 7-9 schematically depicts a process of PUSCH power control according to some embodiments. As an example, a target UE (UE1) has P=−80 and SINR=1 dB, achieving 1 Mbps at BS1. An interfering UE (UE2) has P=−71 and SINR=5 dB, achieving 8 Mbps at BS2. As shown in FIG. 7, UE1 increases transmission power (P_TX). This causes an increase in SINR at BS1 (P=−71, SINR=10 dB, achieving 20 Mbps), while causing a decrease in SINR at BS2 (P=−80, SINR=−4 dB, achieving 0 Mbps).

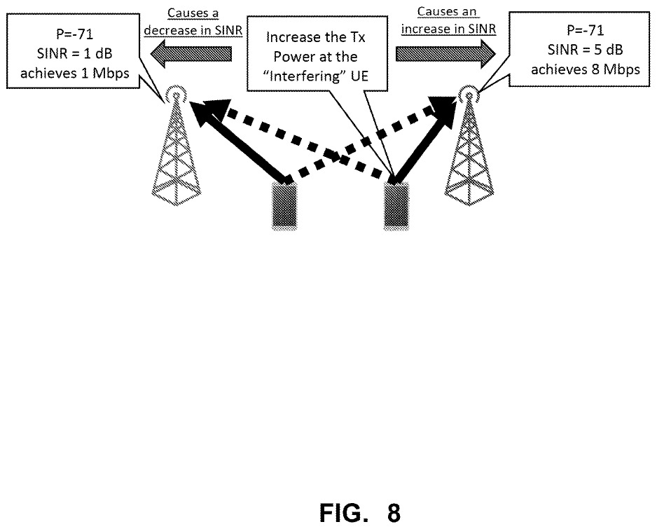

As shown in FIG. 8, UE2 then increases transmission power (P_TX). This causes a decrease in SINR at BS1 (P=−71, SINR=1 dB, achieving 1 Mbps) and an increase in SINR at BS2 (P=−71, SINR=5 dB, achieving 8 Mbps).

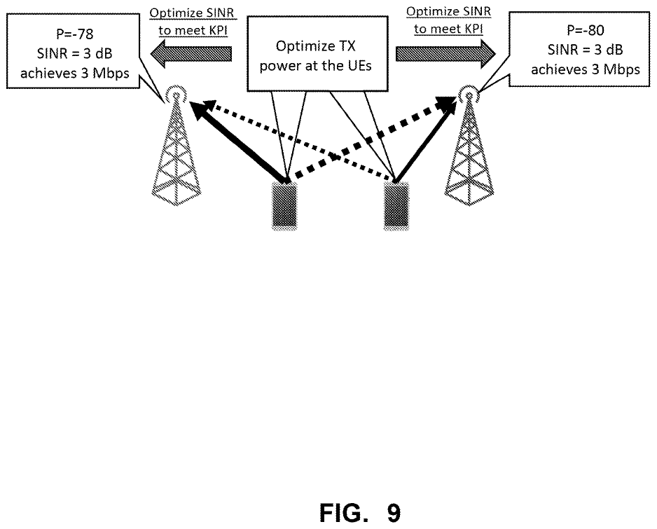

As shown in FIG. 9, UE1 and UE2 optimize their transmit power P_TX respectively, to improve SINR and meet key performance index (KPI). As a result, UE1 has P=−78, SINR=3 dB, achieving 3 Mbps at BS1, and UE2 has P=−80, SINR=3 dB, achieving 3 Mbps at BS2. As described in this example, power control (controlling the UE's transmission power) improves communication.

In some embodiments, the PUSCH BS power control uses a thresholding algorithm to improve the power allocation for PUSCH. In standards, PUSCH power control requires each cell to have a fixed P_0 parameter (updatable via non-RT RIC). Every UE within a cell uses the same P_0 to calculate its transmission power P_TX:

$$P\_TX = min ( P\_Max , P\_ 0 + α * P L + f ( RB ) )$$

where α∈{0, 0.4, 0.5, 0.6, 0.7, 0.8, 0.9, 1}, PL is the pathloss between user and cell, f(RB) is a function of the RB assigned to the UE, and P_0∈{−204, −202, . . . , 22, 24}. In some embodiments, P_0+α*PL+f(RB)) in a function, e.g., min(P_Max, g(P_0+α*PL+f(RB))) where g( ) is a function that depends on grant settings and closed-loop decisions as described in some well-known standards.

In some embodiments of PUSCH UE power control, every UE within a cell uses the same P_0 and an individual P_UE value (controllable in real time or near-RT) to calculate its transmission power P_TX:

$$P\_TX = minP\_Max , P\_ 0 + P\_UE + α * P L + f ( RB ) )$$

where α∈{0, 0.4, 0.5, 0.6, 0.7, 0.8, 0.9, 1}, PL is the pathloss between user and cell, f(RB) is a function of the RB assigned to the UE, P_0∈{−204, −202, . . . , 22, 24} and P_UE ∈{−16, −15, . . . −1, 0, 1, . . . , 14, 15}.

In some embodiments, the power control includes an iterative power control algorithm specifically for PUSCH. Given current and target KPIs (e.g., SINR), the algorithm outputs a power allocation. By iteratively inputting the new KPI achieved by the power allocation, the power control algorithm approaches the target KPIs (assuming the KPIs are feasible). The iterative power control algorithm may be built from basic differential equations and adjusted to operate for PUSCH. The iterative power control algorithm can be used to find power allocations that are optimal or near optimal. Given an optimization function (e.g., max sum SINR, max min SINR, max average bits/symbol or max avg. bits/second, or weighted variations), the algorithm can be used as an internal step to evaluate power allocations.

In some embodiments, a clustering approach can be used to reduce the complexity of PUSCH power control. In such an approach, multiple UEs may be clustered based on their quantized channel measurements then the controller may define a P_UE per cluster. Cluster size may be adjusted depending on controller capabilities or network requirements (e.g., smaller clusters perform better but have higher overhead).

In some embodiments, a method of obtaining a feasible set of SINR limits is provided. The iterative algorithm assumes a target is reachable, and all reachable targets are within feasible set of SINR limits. This can be used to determine which targets (e.g., network requirements) can be reached by power control alone and provides information regarding when clusters should be split up. For example, if a feasible target cannot be reached, the implication is that the cluster should be split up.

In some embodiments, if a power allocation exists such that SINR equals Target and the Target is fixed, then that power allocation can be found in a distributive manner if every BS does the following:

### Repeat:

If the BS's SINR is above the Target, then lower the BS's power by “SINR—Target”
If the BS's SINR is below the Target, then increase the BS's power by “Target—SINR”
Until SINR is at Target

According to this embodiment, with every step taken, the BS moves closer to its target. If the Target is reachable (i.e., feasible), after taking sufficiently many steps the BS will reach its target.

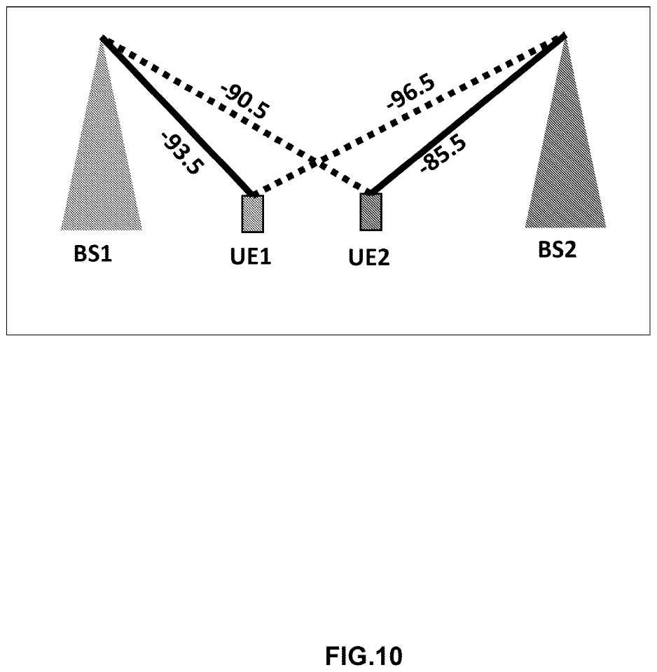

In the example illustrated in FIG. 10, a power allocation for which SINR is 4 for both UEs is sought. Power control may start with power value that solves the trivial SNR problem, but could be any other starting point. Using a mathematical algorithm, the power algorithm is eventually achieved. For example:
Initial values are P0=−96.3 SINR0=1.461, P1=−97.9, and SINR1 0.461
After 1 iteration values are P0=−93.761 SINR0=2.0762, P1=−94.361, and SINR1 2.4083
After 21 iterations values are P0=−83.3471 SINR0=3.7854, P1=−83.9471, and SINR1 3.8286
After 41 iterations values are P0=−80.5388 SINR0=3.8862, P1=−81.1388, and SINR1 3.9094
After 61 iterations values are P0=−78.8474 SINR0=3.9226, P1=−79.4474, and SINR1 3.9384
After 81 iterations values are P0=−77.6331 SINR0=3.9414, P1=−78.2331, and SINR1 3.9534
After 100 iterations values are P0=−76.7231 SINR0=3.9621, P1=−77.333, and SINR1 3.9523
After 1001 iterations values are P0=−66.7626 SINR0=3.9952, P1=−67.3626, and SINR1 3.9962
After 3001 iterations values are P0=−61.9972 SINR0=3.9984, P1=−62.5972, and SINR1 3.9987
After 5001 iterations values are P0=−59.7798 SINR0=3.999, P1=−60.3798, and SINR1 3.9992
After 7001 iterations values are P0=−58.3191 SINR0=3.9993, P1=−58.9191, and SINR1 3.9995
After 9001 iterations values are P0=−57.2279 SINR0=3.9995, P1=−57.8279, and SINR1 3.9996
After 10000 iterations values are P0=−56.7708 SINR0=3.9996, P1=−57.3709, and SINR1 3.9995.

In some embodiments, only integer valued P values are used in PUSCH power control. P=P_0+P_UE. In some embodiments, P_0 is an even integer, but P_UE can be even or odd. If in between iterations, the SINR goes down, the data set closest to the target can be monitored and returned at the end. Below is an example of some embodiments of PUSCH power control being performed, for example:
Initial values are P0=−96 SINR0=1.3394, P1=−97, and SINR1 1.1912
After 1 iterations value are P0=−94 SINR0=2.2366, P1=−95, and SINR1 1.9335
After 2 iterations values are P0=−93 SINR0=1.9159, P1=−93, and SINR1 3.2279
After 3 iterations values are P0=−91 SINR0=3.1825, P1=−92, and SINR1 2.6854
After 4 iterations values are P0=−90 SINR0=3.4065, P1=−91, and SINR1 2.8584
After 5 iterations values are P0=−89 SINR0=3.5931, P1=−90, and SINR1 3.0009
After 6 iterations values are P0=−88 SINR0=3.7473, P1=−89, and SINR1 3.1176
After 7 iterations values are P0=−87 SINR0=3.8737, P1=−88, and SINR1 3.2125
After 8 iterations values are P0=−86 SINR0=3.9769, P1=−87, and SINR1 3.2894
After 9 iterations values are P0=−85 SINR0=4.0606, P1=−86, and SINR1 3.3515
After 10 iterations values are P0=−86 SINR0=2.1283, P1=−85, and SINR1 5.2894.

As shown above, values after 9 iterations are closest as defined by “minimum squared distance to target.

An example algorithm for PUSCH power control provided herein may be characterized as follows:
Input: Targets, RSRPs, and tolerance level of discrepancy between target SINR and SINR measurement (or max number of iterations), and an initial power allocation. Note that in some embodiments, the SINR measurement is a real valued signal but the parameters that can be selected are integer valued. Thus, there can be a difference between the target and the SINR, and a tolerance for how large this difference can be and still be satisfied with the solution.
Repeat
1. Simultaneously at every UE check: If |Target−SINR|>Tolerance, then Power=Power+Target−SINR; else keep power as is for this iteration
2. If a new power allocation results in SINRs with a smaller squared distance to targets, mark it as the closest power allocation
   Until |Target−SINR|<Tolerance for all SINRs for all UEs performing the power control algorithm
   Output: Power allocation that is closest to the targets

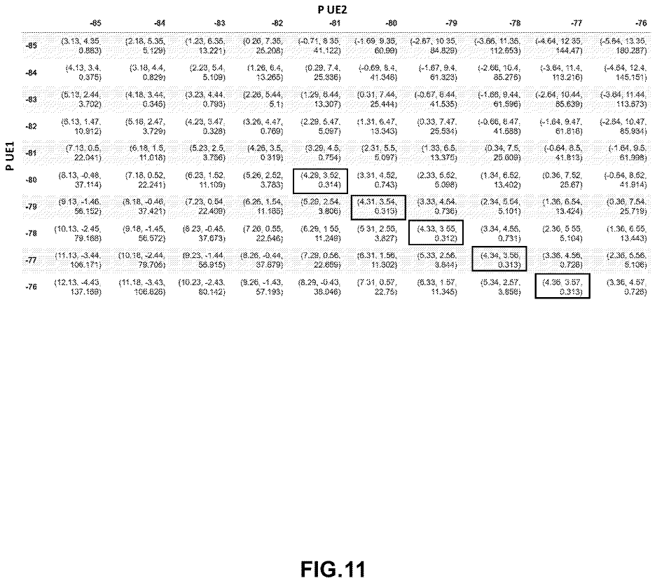

FIG. 11 illustrates an example table listing (SINR of UE1, SINR of UE2, weighted square distance (WSD)) for respective reference signal received power (RSRP) of UE1 and UE2. The data set closest to the target can be found at P_TX1=−78 and P_TX2=−79, with (4.33, 3.55, 0.312), where P_TX1 is power (P) for UE1, and P_TX2 is power for UE2. If tolerance is specified to be “weighted square distance<0.315,” the acceptable data sets indicative of the transmit power for UE1 and UE2 (solutions) include any of the following found in FIG. 11:

| | | (SINR UE1, |
|---|---|---|
| P_TX1 | P_TX2 | SINR UE2, WSD) |
| 80 | 81 | (4.29, 3.52, 0.314) |
| 79 | 80 | (4.31, 3.54, 0.313) |
| 78 | 79 | (4.33, 3.55, 0.312) |
| 77 | 78 | (4.34, 3.56, 0.313) |
| 76 | 77 | (4.36, 3.57, 0.313) |

To address the issue of having multiple solutions, the following may be considered:
3. After the algorithm terminates on a solution, the +/−1 values around the candidate power allocation are checked
4. Solutions for nearby instances should be similar (e.g., the solution for [−92.5, −96.5, −90.5, −85.5] should be close to the solution for [−93.5, −96.5, −90.5, −85.5])
5. Use a rule, e.g., select the smallest P values among candidates

To achieve positive SINRs, positive sum target SINRs may be used (i.e., Target1>0 and Target2>0) such that

$$Target 1 + Target 2 < neigRSRP 1 - servRSRP 1 + neigRSRP 2 - servRSRP 2$$

Alternatively, one of the Targets can be negative and the other positive as long as the “<” equation is still satisfied. This may be advantageous if power allocation is combined with scheduling.

If some P_TX1 for UE1 and P_TX2 for UE2 achieve Target_1 and Target_2 SINRs, then
6.

$$Target 1 = P\_TX1 - L\_Serv 1 - ( P\_TX2 - L\_Interf2 )$$

7.

$$Target 2 = P\_TX2 - L\_Serv2 - ( P\_TX1 - L\_Interf1 )$$

8.

$$Target 1 + Target 2 = - L\_Serv1 + L\_Interf1 - L\_Serv2 + L\_Interf2$$

9. If L_Serv=servRSRP+C and L_Interf=neigRSRP+C, the result described on sum target SINR limit above may be achieved.
With L_Serv1 being the channel pathloss between UE1 and its corresponding serving base station, and L_Interf1 being the channel pathloss between UE1 to the base station serving UE2, i.e., L_Interf1 is the channel over which UE1 interferes upon the signal from UE2. C is a UE dependent value, assumed constant at measurement, that maps the channel pathloss to the reported RSRP measurement.

In some embodiments, RSRP values are expressed as magnitudes (absolute values), i.e., −1*value found in the MR.

With the algorithm above, for any given pair of UEs, the possible SINR values that can be reached are finite and limited. For example, if neigRSRP1−servRSRP1+neigRSRP2−servRSRP2 equals 10, then there is no power allocation that can give both UEs 10 dB SINR. Thus, in some embodiments, power control is limited by the network topology.

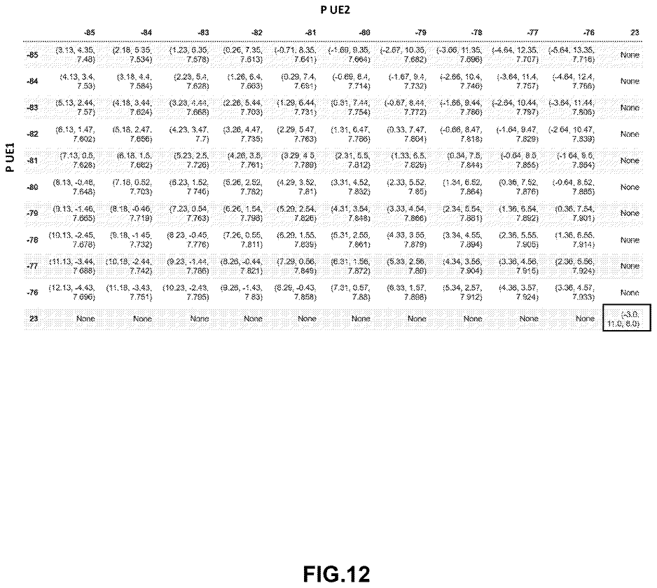

FIG. 12 illustrates an example table listing (SINR of UE1, SINR of UE2, sum of SINR of UE1 and UE2) for RSRP of UE1 and UE2. At P_TX1=23, P_TX2=23, (SINR of UE1, SINR of UE2, sum of SINR of UE1 and UE2)=(−3.0, 11.0, 8.0). The actual sum of SINR of UE1 and UE2 is 7.998 . . . , and is rounded to two decimals to 8.0. For this data set, based on Target1+Target2<neigRSRP1−servRSRP1+neigRSRP2−servRSRP2,

$$\begin{matrix}90.5 - 85.5 + 9 6.5 - 93.5 = 8 \\ SINRBS 1 + SINRBS 2 < 8\end{matrix}$$

In some embodiments, the network controller needs to decide
How many clusters and how are they defined?
Which cluster does each UE belong in?
For each cluster, what is P_UE value for the UEs in this cluster?
   Is this P_UE value going up, staying the same, or decreasing relative to the P_UE value it previously used?
   Which value should P_UE for this cluster be, among the standard, fixed set of values P_UE can take?
   If increasing or decreasing, by how much?
What P_0 value should each BS use?

Multiple options are available for implementing a power control algorithm described above. These options are performed by processing logic that can include hardware (e.g., circuitry, dedicated logic, memory, etc.), software (such as is run on a general-purpose computer system or a dedicated machine), firmware (e.g., software programmed into a read-only memory), or combinations thereof.

For example, one option, referred to herein as option A, includes the processing of the power control algorithm by processing logic iterating over consecutive control periods, using latest measurement reported as current value and updating via the specified change in one iteration of algorithm. For example, in this control period, SINR is 4 and target is 6. The algorithm then instructs an increase in power by 2, and power is increased by 2. In next control period, the power adjustment is similarly repeated. This option is recommended if an update can be made frequently (e.g., on the order of seconds to single digit minutes for near real-time control, on the order of milliseconds for real-time control), and assuming control is capable. This approach should work if the immediate past is indicative of the immediate future, which is certainly the case for channels and many forms of traffic.

Another option, referred to herein as Option B, includes the processing of the power control algorithm by processing logic collecting data, simulating the environment from the data, iterating inside simulator, and for next control period using the output from simulation. For example, option B may collect available data and simulate the next control period. Within simulation, the iterative algorithm may be run, and the output of algorithm may be used in simulation as parameters for next control period. This option is recommended if update is not made frequently and some simulation of the network can be done. If update is made frequently, then this option would require the most computational capability.

Another option, referred to herein as Option C, includes the processing of the power control algorithm by processing logic maintaining historical results for specific areas and times, using historical measurement as the current value and update via the specified change in one iteration of algorithm. For example, last Monday at 7:15 AM this BS had P=−80 and SINR=4. According to the algorithm, in this case, power should be increased by 2, so this Monday at 7:15 AM, P=−78 is used. If data suggests that behavior is statistically similar in same time/locations and cannot be updated frequently, this option is recommended. This method does not require a simulation and can be considered a variation of Option A (e.g., each control period is iterated every predetermined number of days (e.g., once every 7 days)) and in Option A iteration is performed across consecutive control periods) with the benefit of being able to combine data in various ways.

### Example Techniques to Improve and or Optimize Parameters

According to the present disclosure, any parameter of interest may be improved, and potentially optimized. For example, to improve, and potentially optimize, the sum achievable rate, inputs used are the RSRP values, noise, alpha, PMax, PMin, and function describing achievable rate for a given measured SINR (e.g., f(SINR)=B bits/s).

$$\begin{matrix}max \sum {B}_{i} \\ s . t . , f ( {SINR}_{i} ) = {B}_{i} \\ \sum {SINR}_{i} \leq {Limit}_{i}\end{matrix}$$

The algorithm described herein may be used to find the power allocation that achieves the measured SINR of all UEs being controlled (i.e., SINRᵢ for all UEᵢ being controlled).

For example, to improve, and potentially optimize, sum measured SINR across all controlled UE, inputs may be the RSRP values, noise, alpha, PMax, and PMin,

$$\begin{matrix}max \sum {SINR}_{i} \\ s . t . , \sum {SINR}_{i} \leq {Limit}_{i}\end{matrix}$$

The algorithm described herein may be used to find the power allocation that achieves the SINR.

For example, to improve, and potentially optimize, the maximum sum SINR, inputs may be the RSRP values, noise, alpha, PMax, and PMin,

$$\begin{matrix}max □ & \sum SIN {R}_{i} & □ \\ such that & □ & □ \\ □ & □ & □ \\ □ & \sum SIN {R}_{i} \leq {Limit}_{i} & □\end{matrix}$$

The algorithm described herein may be used to find the power allocation that achieves the SINR.

For example, to improve, and potentially optimize, weighted maximum sum SINR, inputs may be the RSRP values, noise, alpha, PMax, PMin, and weights.

$$\begin{matrix}max □ & \sum {w}_{i} SIN {R}_{i} & □ \\ such that & □ & □ \\ □ & \sum {w}_{i} = 1 & □ \\ □ & \sum SIN {R}_{i} \leq {Limit}_{i} & □ \\ & & max \sum {w}_{i} SIN {R}_{i} \\ & & s . t . , \sum SIN {R}_{i} \leq {Limit}_{i} \\ & & \sum {w}_{i} = 1 \\ & & 0 \leq {w}_{i} \leq 1\end{matrix}$$

The algorithm described herein may be used to find the power allocation that achieves the SINR. Typically, variations with weights are described as “fair” with the proportional weight being a fairness metric.

For example, in some embodiments, to improve, and potentially optimize, “fair” maximum sum SINR, for each instance (i.e., pair of rows that describe a two UE and two BS network) found in the data set, the following formulas is used:

$$limit = ( neigRSRP 1 - servRSRP 1 ) + ( neigRSRP 2 - servRSRP 2 )$$

If limit is even->Target1=limit/2 and Target2=limit/2
If limit is odd->Target1=(limit+1)/2 and Target2=(limit−1)/2

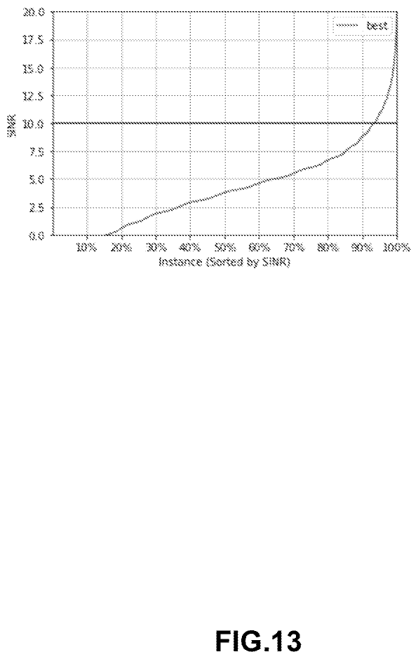

FIG. 13 illustrates an example chart of cumulative instance (%) for SINR. As shown in FIG. 13, ˜15% of all instances are <0 dB SINR, with mean SINR of 3.7 dB.

For example, in some embodiments, to improve, and potentially optimize, maximum minimum sum SINR, the inputs are the RSRP values, noise, alpha, PMax, and PMin,

$$\begin{matrix} & & max min SIN {R}_{i} \\ & & s . t . , \sum SIN {R}_{i} \leq {Limit}_{i} \\ max □ & min ( SIN R ) & □ \\ such that & □ & □ \\ □ & □ & □ \\ □ & \sum SIN {R}_{i} \leq {Limit}_{i} & □\end{matrix}$$

The algorithm described herein may be used to find the power allocation that achieves the SINR.

For example, in some embodiments, to improve, and potentially optimize, some function rate, inputs may be the RSRP values, noise, alpha, PMax, and Pmin, function describing achievable rate for a given SINR (e.g., f(SINR)=B bits/s), and a function g(B_i) which maps the rate to some other value of interest such as service requirement.

$$\begin{matrix}max □ & \sum g ( {B}_{i} ) & □ \\ such that & □ & □ \\ □ & f ( SIN {R}_{i} ) = {B}_{i} & □ \\ □ & \sum SIN {R}_{i} \leq Limit & □ \\ & & max \sum g ( {B}_{i} ) \\ & & s . t . , f ( SIN {R}_{i} ) = {B}_{i} \\ & & \sum SIN {R}_{i} \leq {Limit}_{i}\end{matrix}$$

### Examples of Feasible Targets

From data in measurement reports (MRs), a sum target SINR limit may be derived for any combination of UEs for example based on the following formula:

$$servRSRP - neigRSRP + servRSRP - neigRSRP > Sum SIN R Limit$$

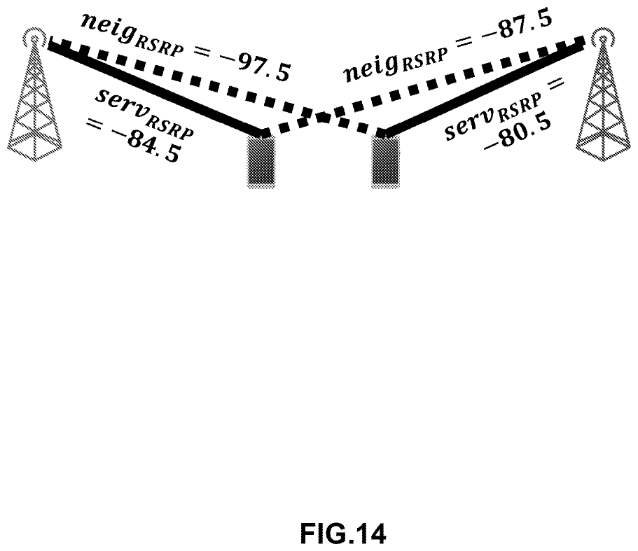

For example, in an example provided in FIG. 14,

$$Sum SIN R Limit = - 8 0.5 - ( - 97.5 ) + ( - 84.5 ) - ( - 87.5 ) = 20$$

For this instance, there exists a power allocation such that Target SINR+Target SINR<20, and that power allocation may be efficiently found. Thus, from historical data, an “average limit” may be found and the set of feasible targets can be selected. The methods provided herein may reduce cumbersome analysis by network engineers. The inequality may be as small as noise power is relative to interference power.

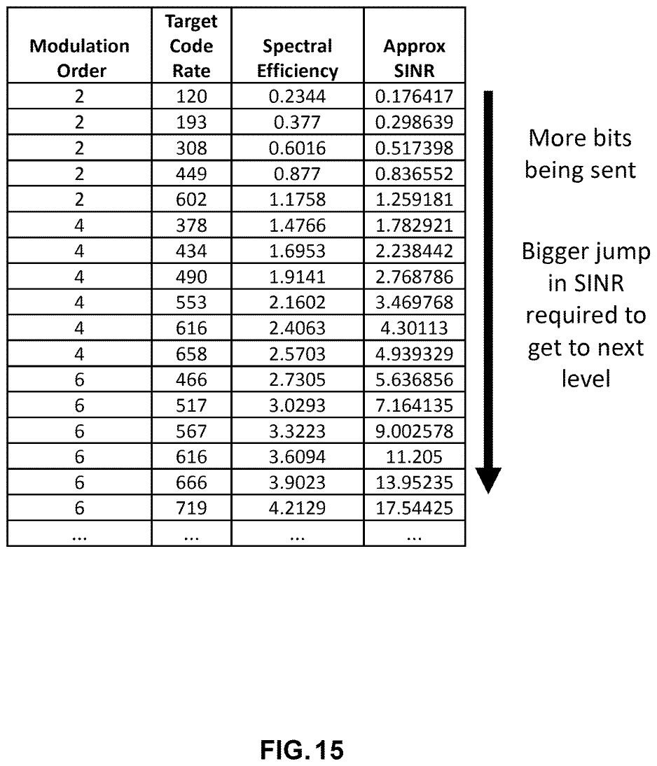

Modulation and coding scheme (MCS) tables for PUSCH exist in standards. FIG. 15 illustrates an example MCS table. Communicating devices may switch between MCS levels to reliably transmit as many bits as possible depending on SINR. In some embodiments, an approximate SINR required to reach each MCS level can be found using the following formula:

$$Approximate SIN R = 1 {0}^{*} log\_ 10 ( {2}^{⋀} ( Spectral Eff . ) - 1 )$$

In various embodiments, the SINR target is set below limit and above SINR required for highest reachable MCS level.

### Identifying a Group of Users (Clustering)

In some embodiments, the network operator may request a review of both the per-BS parameter and per-UE parameter. In some embodiments, all UE in a BS range can move +15/−16 dB away from P_0 via use of P_UE.

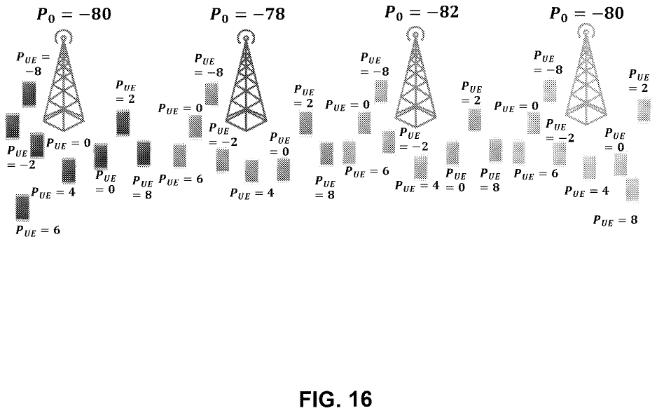

As shown in FIG. 16, there are much more UEs than BSs, which could get complicated. In some embodiments, the complexity may be reduced via clustering. In some embodiments, UEs periodically measure channels and report a quantized value of their measurements. In some embodiments, UEs with similar channels will report the same quantized values. For example, UE1 that measured servRSRP−84.2 and neigRSRP−87.9 and UE2 that measured servRSRP−84.8 and neigRSRP−87.3 may both report servRSRP=−84.5 and neigRSRP=−87.5. Quantized channels may be used as a cluster label. Further, additional data in a MR (e.g., second strongest neighbor RSRP) may be used to segment clusters into smaller clusters if a given cluster is not a good representative for the UEs. If controlling every UE on the network is feasible, it is recommended. However, if controlling every UE is not feasible, clustering makes per-UE power control computationally feasible.

Grouping (clustering) may reduce complexity as the number of groups (clusters) is usually less than the number of UEs. In some embodiments, UEs are grouped based on servRSRP and neigRSRP because data has been already collected during association and is available in the MRs. For example, UEs may be grouped (or clustered) based on their reported servRSRP values and neigRSRP values (e.g., strongest neigRSRP values). For example, UE i and k can be in the same group for BS A when they have the same servRSRP and neigRSRP AND are with the same BS A:

$$( servRSRP , neigRSRP ) \_BS = ( - 80 , - 82 ) \_A$$

In some embodiments, smaller groups (clusters) may be created with additional data from UEs.
e.g. 1, using strongest neighbor and second strongest neighbor RSRPs
e.g. 2, if UEs report their (lat, lon), then the network could create location-based groups
e.g. 3, single element group by using data that uniquely identifies a single UE,

For a given group, e.g., (servRSRP, neigRSRP), the network (e.g., RIC) establishes a function (i.e., lookup table) that returns the power allocation for all UE in the group, e.g., such as

$$f ( servRSRP , neigRSRP ) \_BS = {P}^{′}$$

P′ is defined via an iterative algorithm using guidance derived from network data to establish limits for feasible performance, else to alert an engineer (or higher level of control) of when power control is insufficient to provide adequate service to a UE.

In various embodiments, possible scenarios for P′ include the following:
P′ is such that service requirements are met, so do not change P′
P′ is such that service requirements are exceeded, so lower P′
P′ is such that service requirements are not met, so increase P′

After some iterations (e.g., 1, 2, 3, 4, 5, 6, 7, 8, 9, 10 iterations, e.g., 6 iterations), P′ is sufficient or P′ increases to its limit without improving service. If P reaches its limit without improving service, then this is an indication that service cannot be provided with power control alone.

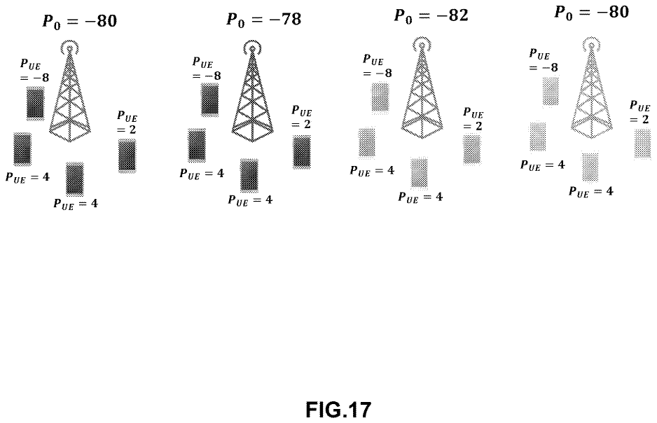

In some embodiments, UEs that report same quantized values may be clustered. As shown in FIG. 17, upon clustering, all UEs within a cluster are treated as if they are the same UE. Then, each cluster may iterate per the power control algorithm.

### Measurement Report Data Key Performance Index

In some embodiments, from the MR data, RSRP values measured from a UE to its serving cell and neighboring cells may be obtained. Depending on mobility and different antennas in different UEs (e.g., mobile phones, etc.), in certain embodiments, a BS informs a UE of which power to use. In other embodiments, a BS announces the different cluster labels and powers, and then a UE could self-identify to a cluster and use the corresponding power. Announcing different cluster labels allows UEs to notice if/when they are in a distinct cluster and use a different power. In some embodiments, a BS collects corresponding key performance indices (KPIs) in such a way as to know in which cluster it is input. For example, Cell A measures the SINR from UE B (Cell A is the serving cell of UE B) and from that can determine that UE B is in cluster C.

In some embodiments, SINR is measured in accordance with the following protocol:
For every ECI A:
   For every ECI B with UEs that can reach A:
      For every UE a in ECI A that can reach ECI B:
         For every UE b in ECI B that can reach A:
         P′_a=f(servRSRP_a, neigRSRP_a)
         P′_b=f(servRSRP_b, neigRSRP_b)
         Calculate SINR with P′_a, P′ b, servRSRP_a, neigRSRP_a, servRSRP_b, and neigRSRP_b

In some embodiments, E[SINR] is measured in accordance with the following protocol:
For every BS A:
p_b=p(A interferes)=RB Utilization of A, where p(A interferes) is the probability that A interferes
   For every ECI B with UEs that can reach A:
   p_a=p(B interferes)=RB Utilization of B
      For every UE a in BS A that can reach BS B:
         For every UE b in BS B that can reach A:
         P′_a=f(servRSRP_a, neigRSRP_a)
         P′_b=f(servRSRP_b, neigRSRP_b)
         Calculate SINR with P′_a, P′ b, servRSRP_a, neigRSRP_a, servRSRP_b, and neigRSRP_b
         Calculate SNR with P′ a, P′ b, servRSRP_a andservRSRP b
         Calculate E[SINR] as SINR*p(interference)+SNR*p(no interference)

Function b(SINR) returns a number of bits for a given SINR (or SNR) value (cf., MCS table) may be defined. To obtain E[Bits/s]. the number of RBs used per second may be defined. In some embodiments, E[Bits/RB] is measured in accordance with the following protocol:

For every BS A:
p_b=p(A interferes)=RB Utilization of A
   For every ECI B with UEs that can reach A:
   p_a=p(B interferes)=RB Utilization of B
      For every UE a in BS A that can reach BS B:
         For every UE b in BS B that can reach A:
         P′_a=f(servRSRP_a, neigRSRP_a)
         P′_b=f(servRSRP_b, neigRSRP_b)
         Calculate SINR with P′_a, P′ b, servRSRP_a, neigRSRP_a, servRSRP_b, and neigRSRP_b
         Calculate SNR with P′_a, P′_b, servRSRP_a and servRSRP_b
         Calculate E[bits/RB] as b(SINR)*p(interference)+b(SNR)*p(no interference)

In some embodiments, E[SINR] is obtained from the periodic MR. Other KPIs may be obtained from the data collection. For example, if the coding-modulation scheme (CMS) and resource block utilization data are known, in some embodiments, an estimate of the average bits/sec is obtained from the SINR. Function f(E[SINR])=E[b] bits/sec may be inferred from the CMS. Other KPIs may also be obtained from reports or higher layer with some delay.

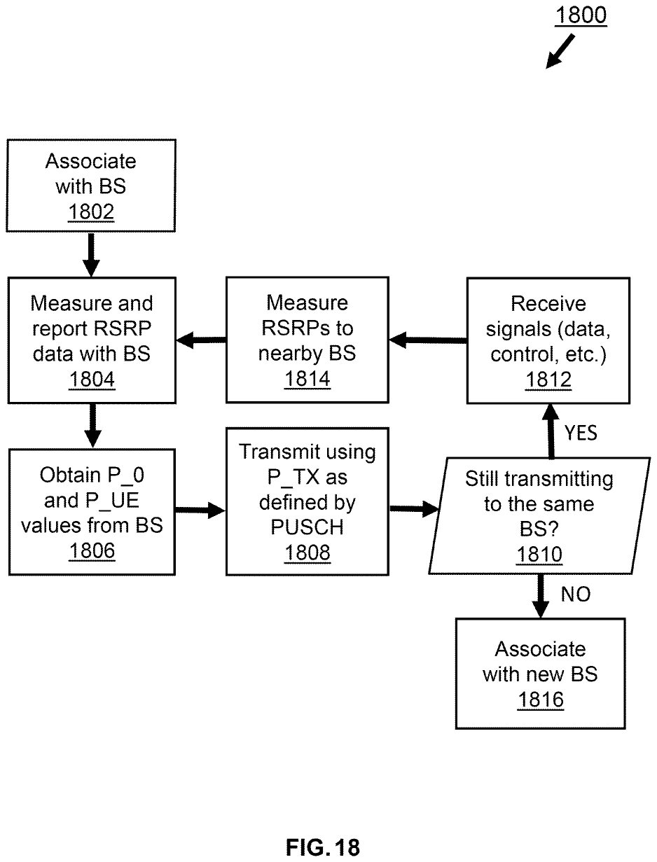

FIG. 18 illustrates some embodiments of a process for wireless communication by a UE for PUSCH power control. Referring to FIG. 18, process 1800 begins at processing block 1802 where processing logic associates the UE with a BS. Process 1800 continues at processing block 1804 where processing logic measures RSRP data to the BS and reports it to the BS. Process 1800 continues at processing block 1806, where processing logic obtains P_0 and P_UE values from the BS. Then process 1800 continues at processing block 1808, where processing logic transmits using P_TX as defined by PUSCH. Next, at processing block 1810 where processing logic verifies whether the UE is still transmitting to the same BS. If the UE is not transmitting to the same BS, process 1800 transitions to processing block 1816 where processing logic associates the UE with a new BS. If the UE is transmitting to the same BS, process 1800 transitions from processing block 1810 to processing block 1812 where processing logic receives signals (e.g., data, control) from the BS. Process 1800 continues to processing block 1814 where processing logic measures RSRPs to a neighbor BS and then transitions to processing block 1804 where processing logic measures RSRP data and reports to the BS that the UE is associated with. Process 1800 may continue through the operations as described in FIG. 18.

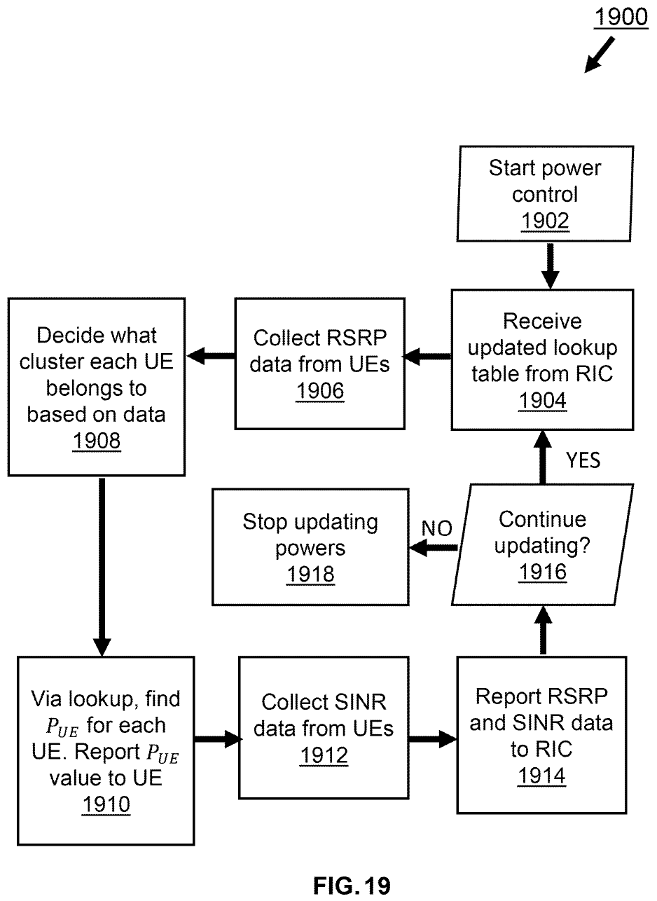

FIG. 19 illustrates some embodiments of a process for wireless communication by a BS for PUSCH power control. Referring to FIG. 19, process 1900 begins at processing block 1902 where processing logic starts power control. Process 1900 continues at processing block 1904 where processing logic receives an updated lookup table from the network (e.g., RIC). A “lookup table” as used herein refers to a function that given a group label will return the power allocation for all UEs in the group, e.g., by way of a table providing P_0 values and P_UE values for UEs and/or clusters. Process 1900 continues at processing block 1906 where processing logic collects RSRP data from UEs. Then, at processing block 1908, processing logic determines to which cluster each UE belongs based on the data. Process 1900 continues to processing block 1910 where processing logic determines P_UE for each UE for each UE, and reports the P_UE value to the UE. Thereafter, at processing block 1912 processing logic collect SINR data from the UEs. Process 1900 continues at processing block 1914 where processing logic reports RSRP and SINR data to the network (e.g., RIC) and at processing block 1916 where processing logic verifies that the network is continuing to update the power parameters P_0 and P_UE for the UEs (and then the UE uses these values to decide the transmit power). If the network is no longer updating their transmit powers, process 1900 continues at processing block 1918 where processing logic stops updating the power control. If the network is still updating transmit powers of the UEs, process 1900 continues from processing block 1916 to processing block 1904 where processing logic receives an updated lookup table from the network (e.g., RIC). Process 1900 may continue through the steps described herein.

Collection of data can be performed faster than how often data is reported to the network (e.g., RIC). Thus, the process can loop as shown in FIG. 19, or collection of data can be faster and/or more frequent than reporting the data to RIC in the process.

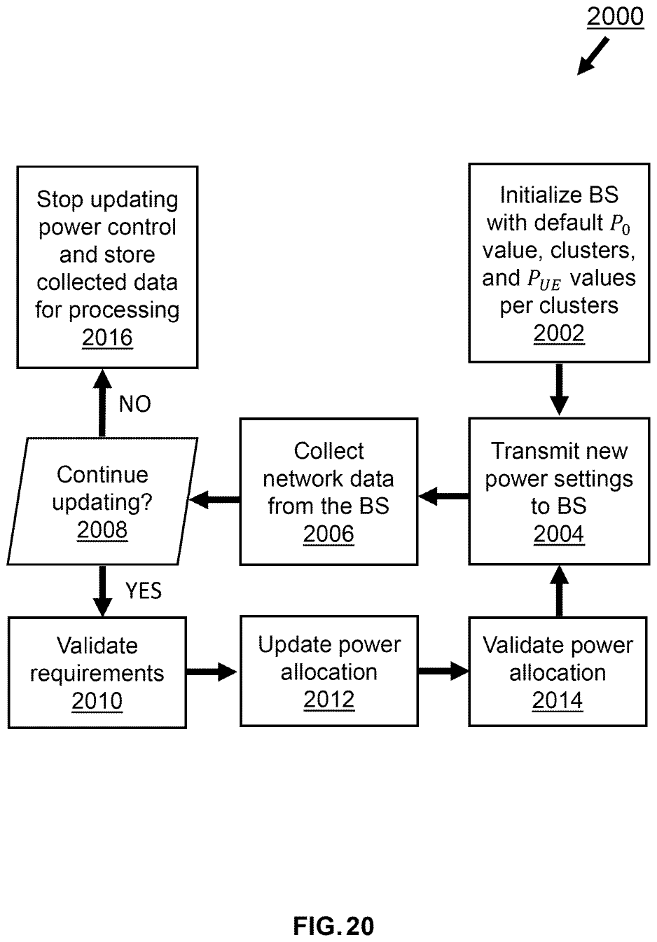

FIG. 20 illustrates some embodiments of a process for wireless communication by a network for PUSCH power control. Referring to FIG. 20, process 2000 begins at processing block 2002 where processing logic initializes a BS with default P_0 value, clusters, and P_UE values per clusters. Process 2000 continues at processing block 2004 where processing logic transmits new power settings to BS and at processing block 2006 where processing logic collects network data from the BS. Process 2000 continues at processing block 2008 where processing logic verifies whether the network continues to update transmit powers for the UEs. If the network is no longer updating powers, process 2000 transitions to processing block 2016 where processing logic stops updating the power control. If the network is still updating powers, process 2000 transitions from processing block 2008 to processing block 2010 where processing logic validates service requirements (e.g., a target SINR being aimed for). Thereafter, process 2000 continues at processing block 2012 where processing logic updates the power allocation. Process 2000 continues at processing block 2014 where processing logic validates the power allocation. Then process 2000 transitions to processing block 2004 where processing logic transmits new power settings to the BS. Process 2000 may continue through the steps described herein.

### Requirements

In some embodiments, the “requirements” are guided by what is known from the sum SINR limits, QoE requirements, or MCS tables. For example, for the Sum SINR limit:

$$n e i g R S R P 0 - serv\_RSRP0 + neigRSRP 1 - serv\_RSRP1 > Sum SIN R limit$$

For example, if a requirement sets forth that an SINR higher than the sum SINR limit is required, then that requirement cannot be met with power control alone, and some scheduling approach or other approach would be needed. For example, in some embodiments, if the next MCS level is beyond the Sum SINR limit, then the network operates below that limit.

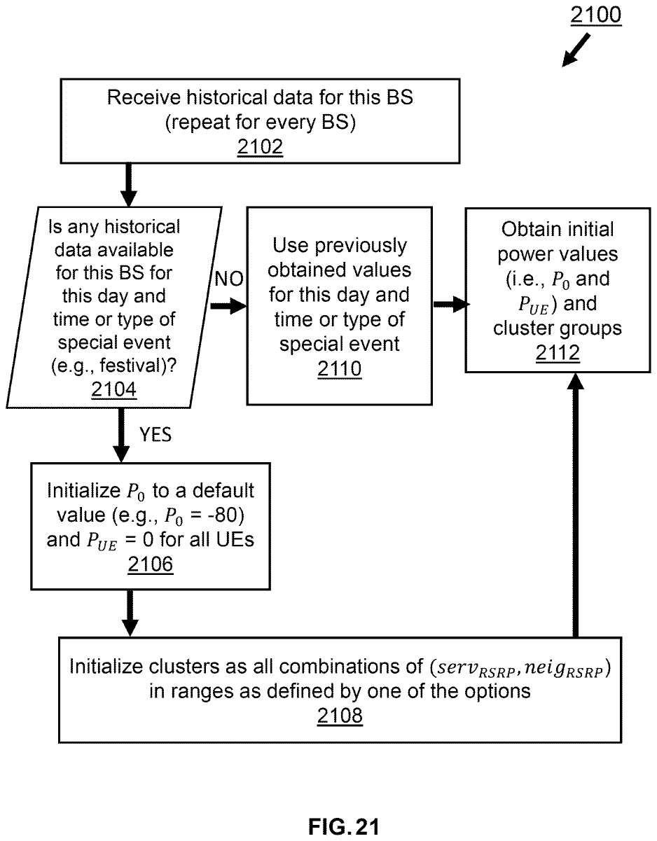

FIG. 21 illustrates some embodiments of a process for initializing values, for example as described in processing block 2002 in FIG. 20. Referring to FIG. 21, process 2100 begins at processing block 2102 where processing logic receives historical data for this BS as an input. Processing block 2102 is repeated for every BS. Process 2100 continues at processing block 2104 where processing logic verifies whether any historical data is available for this BS for this day and time or type of special event (e.g., festival). “Historical data” as used herein refers to a previous power allocation (P_0 and P_UE), clustering groups, and performance associated with the power allocation that has been used previously. In some embodiments, historical data is used in the process described herein to provide a good starting point for the algorithm.

If there is historical data available for this BS for this day and time or type of special event, process 2100 transitions from processing block 2104 to processing block 2106 where processing logic initializes P_0 to a default value (e.g., P_0=−80) and P_UE=0 for all UEs. Process 2100 continues at processing block 2108 where processing logic clusters as all combinations of (servRSRP, neigRSRP) in ranges as defined by one of the following options in various embodiments:
Option 1 (small exhaustive): Set default range for servRSRP is [>−75.5, −75.5, −76.5, . . . , −94.5, −95.5, <−95.5] and for neigRSRP is [>−80.5, −80.5, −81.5, . . . , −104.5, −105.5, <−105.5] or some other fixed limited range;
Option 2 (big exhaustive): Range for servRSRP and neigRSRP is the entire 98 possible reported values for RSRP; or
Option 3 (singular): Start with a single cluster and allow it to be broken down through iterations of the algorithm.

Process 2100 continues to processing block 2112 to obtain initial power values (i.e., P_0 and P_UE) and cluster groups.

At processing block 2104, if there is no historical data available for this BS for this day and time or type of special event, process 2100 transitions from processing block 2104 to processing block 2110 where processing logic uses previously obtained values for this day and time or type of special event, and then process 2100 continues to processing block 2112 where processing logic obtains initial power values (i.e., P_0 and P_UE) and cluster groups.

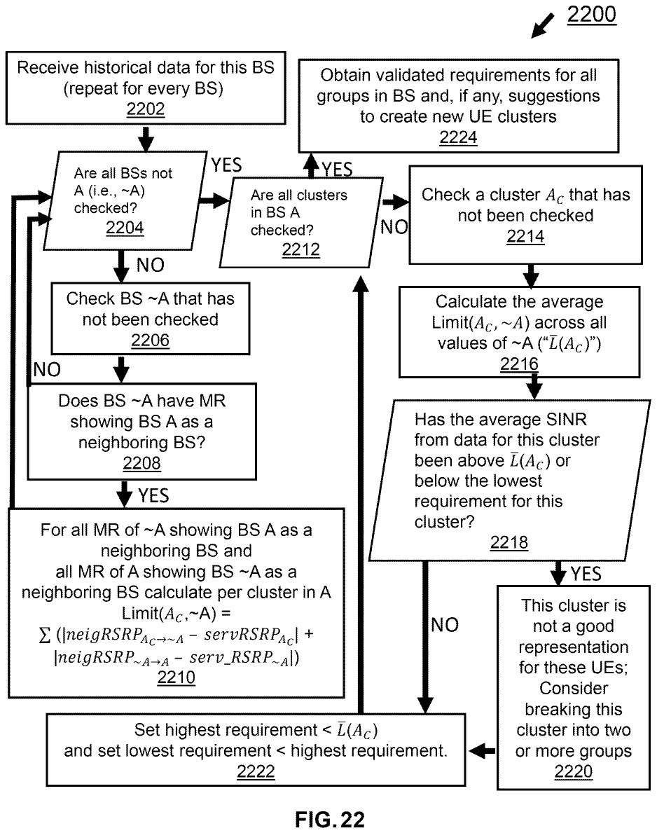

FIG. 22 illustrates some embodiments of a process for validating requirements, for example as described in processing block 2010 in FIG. 20. Referring to FIG. 22, process 2200 begins from processing block 2202 where processing logic receives historical data for this BS as input. Processing block 2202 is repeated for every BS. “Historical data” may include a previous power allocation (P_0 and P_UE), clustering groups, and performance of said power allocation that has been used previously. In some embodiments, historical data is used in the process described herein to provide a good starting point for the algorithm.

Process 2200 continues at processing block 2204 where processing logic verifies whether all relevant BSs that are not A (e.g., neighbor BS, “˜A”) have been checked. If not all relevant BSs˜A have been checked, process 2200 transitions to processing block 2206 where processing logic checks BS˜A that has not been checked and then continues at processing block 2208 where processing logic verifies whether BS˜A has MR showing BS A as a neighboring BS. In some embodiments, an MR includes any relevant data characterizing the UE, BS, and their communication, including RB utilization data, servRSRP, neigRSRP, SINR values, or another key performance indicator (KPI) that depends on SINR (e.g., bitrate). If BS˜A does not have MR showing BS A as a neighboring BS, process 2200 transitions to processing block 2204 where processing logic verifies if all other relevant BSs˜A have been checked. At processing block 2208, if BS˜A has an MR showing BS A as a neighboring BS, process 2200 transitions to processing block 2210 where processing logic calculates per cluster in A:

$$Limit ( A\_C , ∼ A ) = \sum ( \vert neigRSRP\_ ( A\_C \to ∼ A ) - servRSRP\_ ( A\_C ) \vert + \vert neigRSRP\_ ( ∼ A \to A ) - serv\_RSRP \_ ( ∼ A ) \vert ) ,$$

where servRSRP_(A_C) is the serving RSRP from a UE in cluster C of BS A to ECI A and neigRSRP_(A_C→˜A) is the neighbor RSRP value from a UE in cluster C of BS A to ECI˜A. Process 2200 continues at processing block 2204 where processing logic verifies whether all other relevant BSs˜A have been checked.

At processing block 2204, if all relevant BSs˜A have been checked, process 2200 transitions to processing block 2212 where processing logic verifies whether all clusters in BS A have been checked. If not all clusters in BS A have been checked, process 2200 transitions to processing block 2214 where processing logic checks a cluster A_C that has not been checked. Process 2200 continues at processing block 2216 where processing logic calculates the average Limit(A_C, ˜A) across all values of ˜A, referred to as “L⁻(A_C)”. Process 2200 continues at processing block 2218 where processing logic verifies whether the average SINR from data for this cluster has been above L⁻(A_C) or below the lowest service requirement (e.g., the lowest target SINR) for this cluster. If the average SINR from data for this cluster has been above L⁻(A_C) or below the lowest requirement for this cluster, process 2200 continues to processing block 2220 where processing logic determines whether to break this cluster into two or more groups, as the average SINR for this cluster indicates that this cluster is not a good representation for the UEs contained therein. At processing block 2218, if the average SINR from data for this cluster has been between L⁻(A_C) and the lowest requirement for this cluster, process 2200 continues at processing block 2222 where processing logic sets the highest requirement<L⁻(A_C) and set lowest requirement<highest requirement. The highest requirement indicates the network limit, where using power higher than the highest requirement will hurt another group of UEs. Process 2200 continues to processing block 2212 to verify if all clusters in BS A have been checked. If all clusters in BS A have been checked, process 2200 continues at processing block 2224 where processing logic obtains validated requirements for all groups in BS and, if any, suggestions to create new UE clusters.

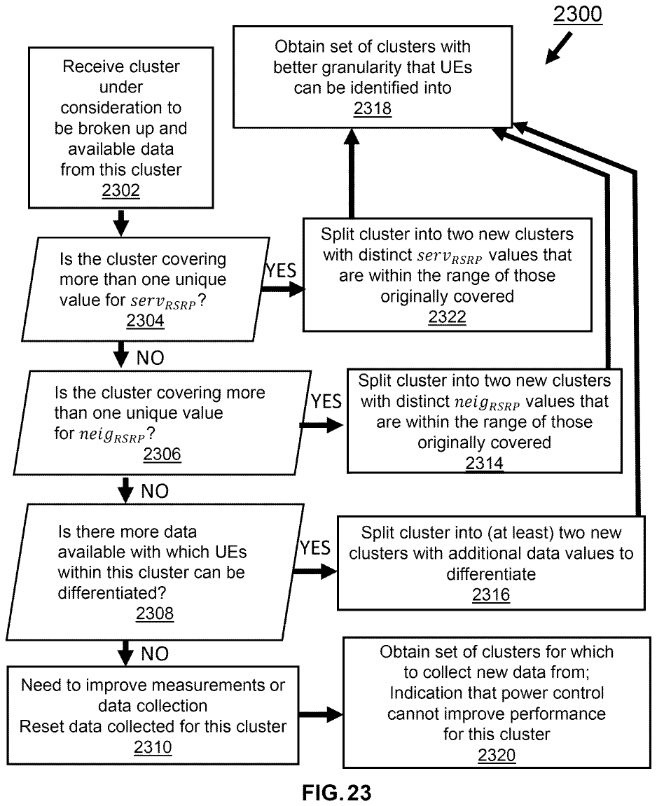

FIG. 23 illustrates some embodiments of a process for breaking up clusters, for example as described in FIGS. 21 and 22. Referring to FIG. 23, process 2300 begins from processing block 2302 where processing logic receives cluster under consideration to be broken up and available data from this cluster. Process 2300 continues at processing block 2304 where processing logic verifies whether the cluster is covering more than one unique value for servRSRP. If the cluster is covering more than one unique value for servRSRP, process 2300 proceeds to processing block 2322 where processing logic splits the cluster into two new clusters with distinct servRSRP values that are within the range of those originally covered. Process 2300 then continues to processing block 2318 where processing logic obtains a set of clusters with better granularity that UEs can be identified into.

At processing block 2304, if the cluster is not covering more than one unique value for servRSRP, process 2300 transitions to processing block 2306 where processing logic verifies whether the cluster is covering more than one unique value for neigRSRP. If the cluster is covering more than one unique value for neigRSRP, process 2300 proceeds to processing block 2314 where processing logic splits the cluster into two new clusters with distinct neig.RSRP values that are within the range of those originally covered. Process 2300 then continues to processing block 2318 where processing logic obtains a set of clusters with better granularity into which UEs can be identified.

At processing block 2306, if the cluster is not covering more than one unique value for neigRSRP, process 2300 proceeds to processing block 2308 where processing logic verifies whether there is more data available with which UEs within this cluster can be differentiated. If there is more data available with which UEs within this cluster can be differentiated, process 2300 proceeds to processing block 2316 where processing logic splits the cluster into at least two new clusters with additional data values to differentiate. Process 2300 then continues to processing block 2318 where processing logic obtains a set of clusters with better granularity that UEs can be identified into.

At processing block 2308, if there is no more data available with which UEs within this cluster can be differentiated, process 2300 proceeds to processing block 2310 to reset data collected for this cluster, as the measurements or data collection need to be improved. Process 2300 continues to processing block 2320 to obtain set of clusters for which to collect new data from. The data provided thus far indicates that power control cannot improve performance for this cluster.

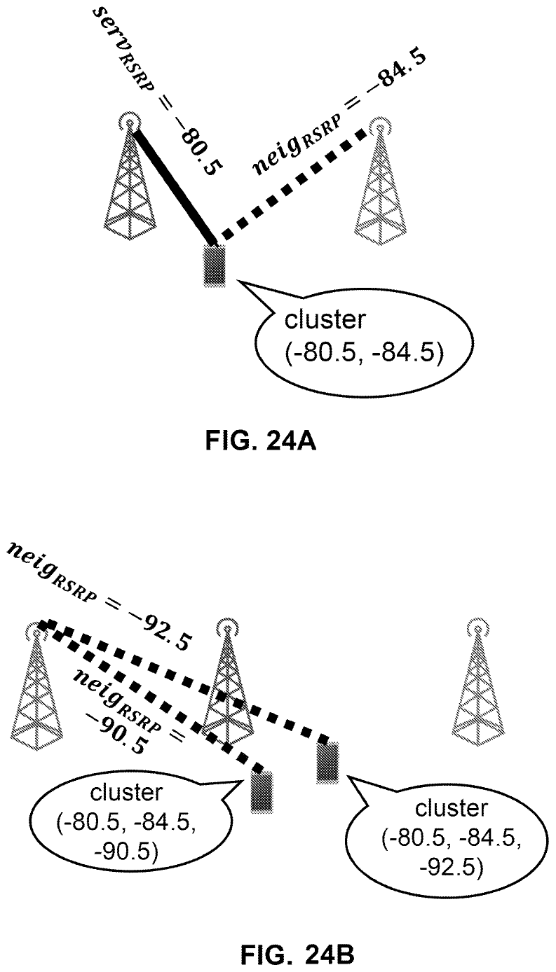

FIGS. 24A and 24B illustrate an example aspect of breaking up clusters, for example as described in FIGS. 21 and 22. As shown in FIG. 24A, if there are users under the cluster label of (servRSRP, neigRSRP1)=(−80.5, −84.5) that needs to be split up, Option 1 described above in relation to FIG. 21 could create new clusters labeled (servRSRP, neigRSRP1, neigRSRP2)=(−80.5, −84.5, −90.5) and (−80.5, −84.5, 92.5), each having different neigRSRP to another neighbor BS2, as shown in FIG. 24B.

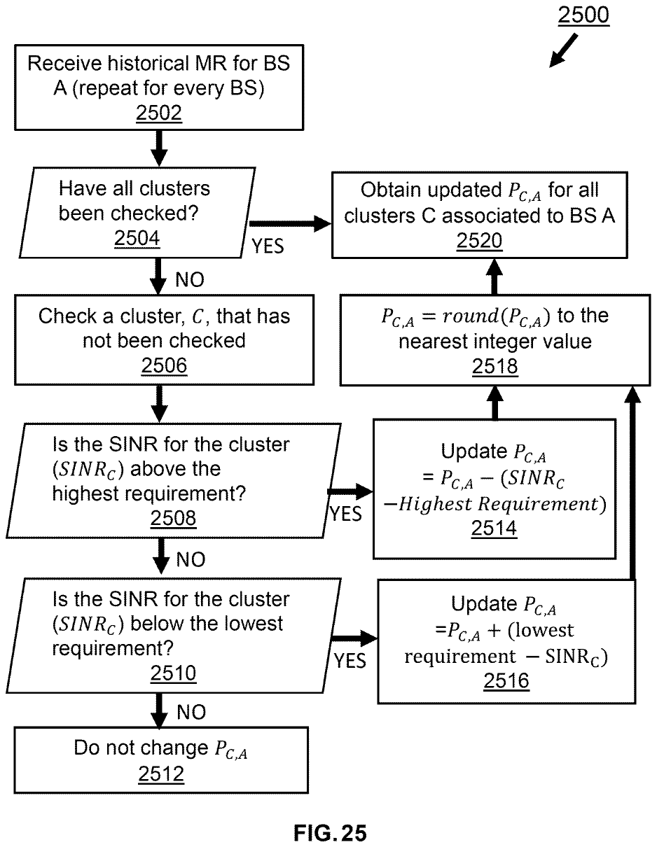

FIG. 25 illustrates some embodiments of a process for updating power allocation, for example as described in FIG. 20. Referring to FIG. 25, process 2500 begins at processing block 2502 where processing logic receives historical data (e.g., MR) for this BS as an input. Processing block 2502 is repeated for every BS. In some embodiments, an MR includes any relevant data characterizing the BS, including RB utilization data, servRSRP, neigRSRP, SINR values, or another key performance indicator (KPI) that depends on SINR (e.g., bitrate). Process 2500 continues at processing block 2404 where processing logic verifies whether all clusters have been checked. If all clusters have not been checked, process 2500 proceeds to processing block 2506 where processing logic checks a cluster C, that has not been checked and then continues at processing block 2508 where processing logic verifies whether the SINR for the cluster (SINR_C) is above the highest service requirement. If SINR_C is above the highest requirement, process 2500 proceeds at processing block 2514 where processing logic updates

$$P\_ ( C , A ) = P\_ ( C , A ) - ( SINR\_C - Highest Requirement ) .$$

Thereafter, process 2500 continues at processing block 2518 where processing logic rounds P_(C,A) to the nearest integer value and continues at processing block 2520 where processing logic obtains updated P_(C,A) for all clusters C associated to BS A.

At processing block 2508, if the SINR for the cluster (SINR_C) is not above the highest requirement, process 2500 proceeds to processing block 2510 where processing logic verifies whether SINR_C is below the lowest requirement. If SINR_C is below the lowest requirement, process 2500 proceeds to processing block 2516 where processing logic updates

$$P\_ ( C , A ) = P\_ ( C , A ) + ( lowest requirement - SINR\_C ) .$$

Then process 2500 continues at processing block 2518 where processing logic rounds P_(C,A) to the nearest integer value and then at processing block 2520 where processing logic obtains updated P_(C,A) for all clusters C associated to BS A.

At processing block 2150, if SINR_C is not below the lowest requirement, process 2500 proceeds to processing block 2512 and P_(C,A) is not changed.

At processing block 2504, if all clusters have been checked, process 2500 proceeds to processing block 2520 where processing logic obtains updated P_C. A for all cluster C associated to BS A.

In some embodiments, approximate SINR required to reach each level may be inferred from a MCS index table, e.g., as provided in FIG. 15. These approximations may be used as guidance for highest and lowest requirements for SINR described above.

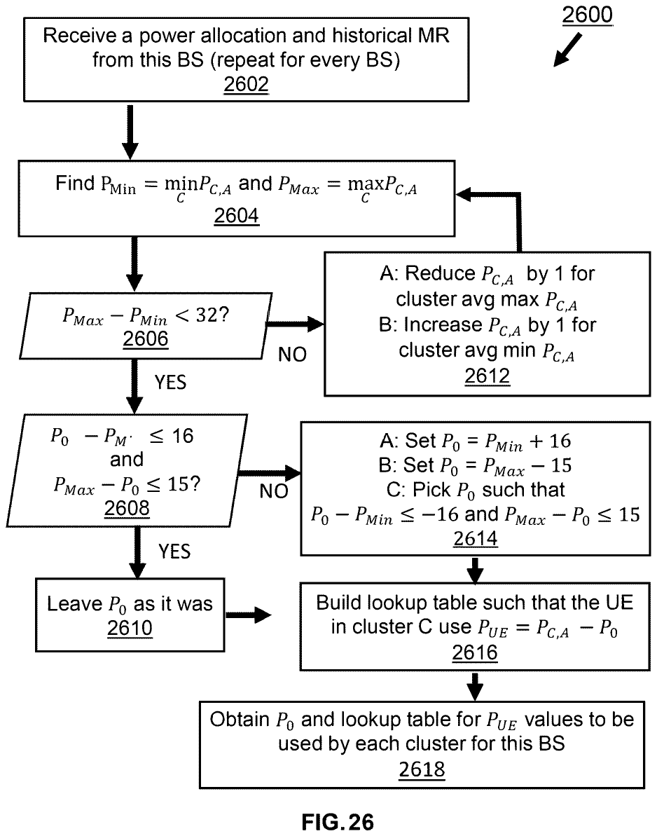

FIG. 26 illustrates some embodiments of a process for validating power allocation, for example as described in processing block 2014 in FIG. 20. Referring to FIG. 26, process 2600 begins at processing block 2602 where processing logic receives a power allocation and historical data (e.g., a MR) for this BS as an input. Processing block 2602 is repeated for every BS. In some embodiments, the MR includes any relevant data characterizing the BS, including RB utilization data, servRSRP, neigRSRP, SINR values, or another key performance indicator (KPI) that depends on SINR (e.g., bitrate). Process 2600 continues to processing block 2604 where processing logic determines P_Min=minTC P_(C,A) and P_Max=maxTC P_(C,A). Process 2600 continues at processing block 2606 where processing logic verifies whether P_Max−P_Min<32. If P_Max−P_Min>32, process 2600 proceeds to processing block 2612 where processing logic performs one of the two options:
Option A: Reduce P_(C,A) by 1 for cluster avg max P_(C,A)
Option B: Increase P_(C,A) by 1 for cluster avg min P_(C, A)
   Selection between the options can be based on determining if low interference is preferred over achieving targets or vice versa. Option A prefers keeping lower interference. Option B prefers achieving target SINRs.

Process 2600 continues at processing block 2604 where processing logic determines P_Min=minTC P_(C,A) and P_Max=maxTC P_(C,A). Process 2600 may continue through the steps described above.

At processing block 2606, if P_Max−P_Min<32, process 2600 proceeds to processing block 2608 where processing logic verifies whether P_0−P_Min<−16 and P_Max−P_0 K 15. If P_0−P_Min<−16 and P_Max−P_0<15, process 2600 proceeds to processing block 2610 where processing logic leaves P_0 as it was. Thereafter, process 2600 continues at processing block 2616 where processing logic builds the lookup table such that the UE in cluster C uses P_UE=P_(C,A)−P_0 and then at processing block 2618 where processing logic obtains P_0 and lookup table for P_UE values to be used by each cluster for this BS.

At processing block 2608, if P_0−P_Min>−16 or P_Max−P_0>15, process 2600 proceeds to processing block 2614 where processing logic performs one of the three options:
A: Set P_0=P_Min+16
B: Set P_0=P_Max−15
C: Pick P_0 such that P_0−P_Min<16 and P_Max−P_0<15
   As for selecting between the options, option A prefers keeping lower interference, option B prefers achieving higher target SINRs, and option C is if it is desirable to set preferences or have other limits on transmit power.

Process 2600 proceeds at processing block 2616 where processing logic builds the lookup table such that the UE in cluster C uses P_UE=P_(C,A)−P_0 and then at processing block 2618 where processing logic obtains P_0 and lookup table for P_UE values to be used by each cluster for this BS.

In some embodiments of wireless communication for the network (e.g., RIC) for PUSCH power control, the network (e.g., RIC) performs the following actions:
Obtain service requirement definitions for the BS it controls (from data analysis, engineers, or higher controller);
Periodically gather data to identify UE groups and be able to calculate KPI(s) for each UE group;
From data and given service requirements per BS, for every BS the RIC controls, it defines the function f(servRSRP, neigRSRP)_BS; for example, from f(servRSRP, neigRSRP)_BS=f(−80,−82)_A, UE i and UE k would obtain the P′=P_UE+P_0 value to use in PUSCH. For example, P_TX=min (23, P′+αserv_RSRP+C));
Update each BS with its new f(servRSRP, neigRSRP)_BS;
Gather data;
   Measurement reports, throughput, schedules, and all available data such that a measurement of the KPI can be obtained and the UEs differentiated
   For example, UEs may be differentiated into groups depending on their (serv_RSRP, neigRSRP) combination and with MRs, power allocations & schedules we can calculate throughput
   Multiple UEs may have the same (serv_RSRP, neigRSRP), instead of each UE being uniquely identified
Control the function f(serv_RSRP, neigRSRP)_BS=P′ for every BS, based on data and given service requirements per BS;
   f(serv_RSRP, neigRSRP)_BS informs UEs in the BS that if they see local information (serv_RSRP, neigRSRP) they should use P_TX=min(23, P′ +αserv_RSRP+C), i.e., P′=P_UE+P_0; and
Update each ECI with its new f(serv_RSRP, neigRSRP)_ECI.

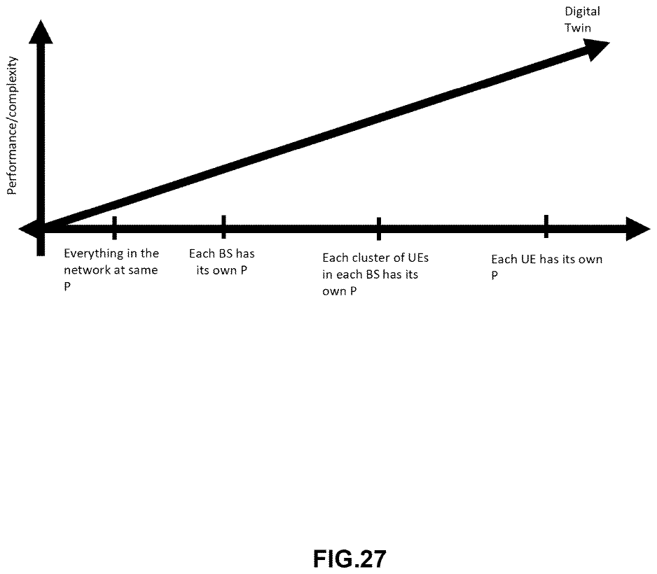

FIG. 27 illustrates an example diagram of the relationship between individuality in power (P) among UEs or BSs and performance. Performance may improve with increased individuality in power in the following order:
everything in the network at same P (lower performance);
each BS has its own P;
each cluster of UEs in each BS has its own P;
each UE has its own P (higher performance)

The complexity also increases with increased individuality in power in the above order.

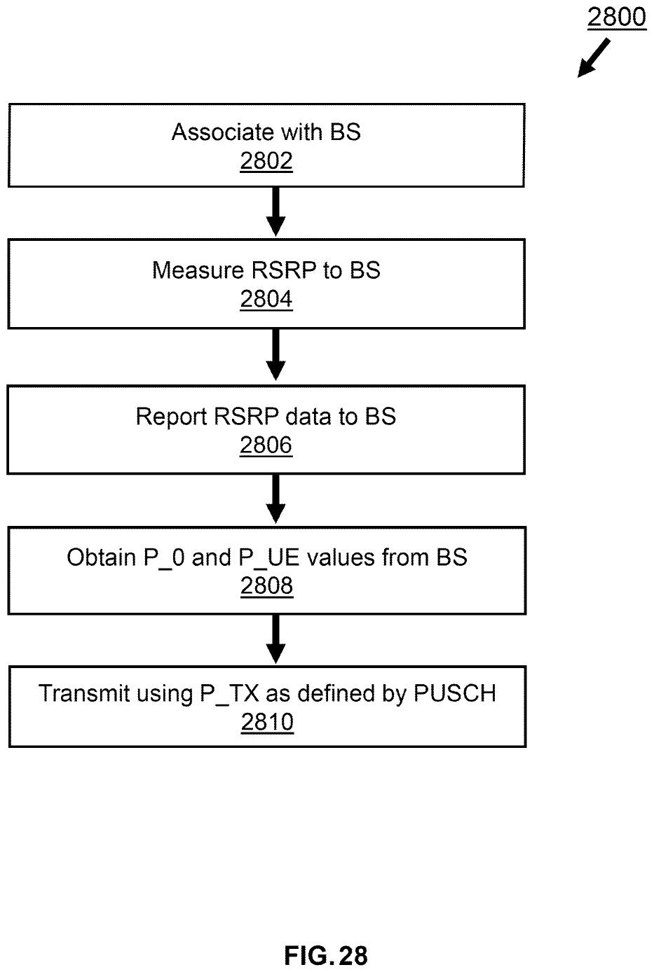

FIG. 28 illustrates some embodiments of a process for wireless communication by a UE for PUSCH power control. Referring to FIG. 28, process 2800 begins at processing block 2802 where processing logic associates the UE with a BS. Process 2800 continues at processing block 2804 where processing logic measures RSRP data to the BS and then at processing block 2806, processing logic reports the RSRP data to the BS. Process 2800 continues at processing block 2808, where processing logic obtains P_0 and P_UE values from the BS and then at processing block 2810, processing logic transmits using P_TX as defined by PUSCH.

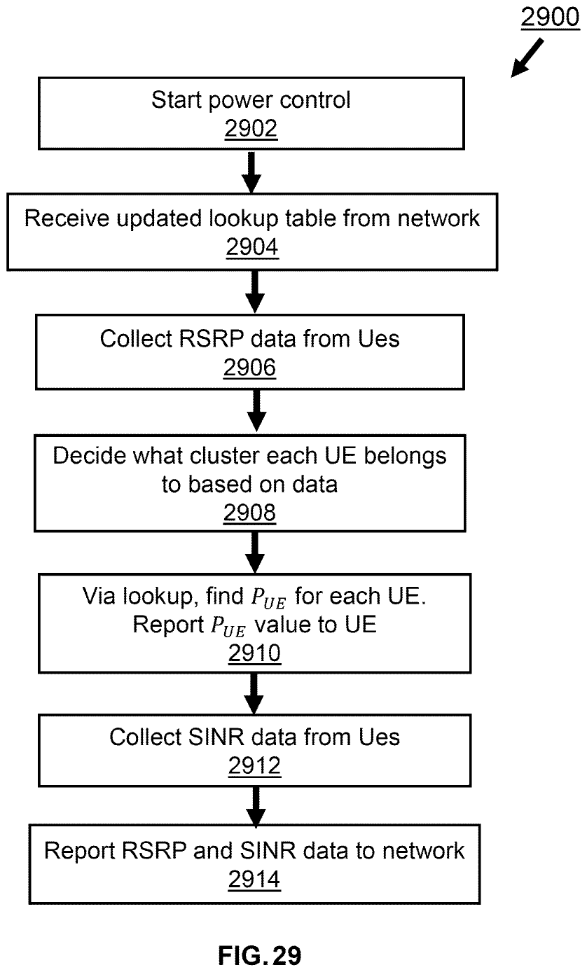

FIG. 29 illustrates some embodiments of a process for wireless communication by a BS for PUSCH power control. Referring to FIG. 29, process 2900 begins at processing block 2902 where processing logic starts power control. Process 2900 continues at processing block 2904 where processing logic receives an updated lookup table from the network (e.g., RIC). Process 2900 continues to processing block 2906 where processing logic collects RSRP data from UEs. Process 2900 continues at processing block 2908 where processing logic determines to which cluster each UE belongs based on the data (e.g., for initialization, RSRP data is used). Process 2900 continues to processing block 2910 where processing logic determines P_UE for each UE for each UE, and reports the P_UE value to the UE. Then process 2900 continues at processing block 2912 where processing logic collects SINR data from the UEs, and then at processing block 2914 processing logic reports RSRP and SINR data to the network (e.g., RIC).

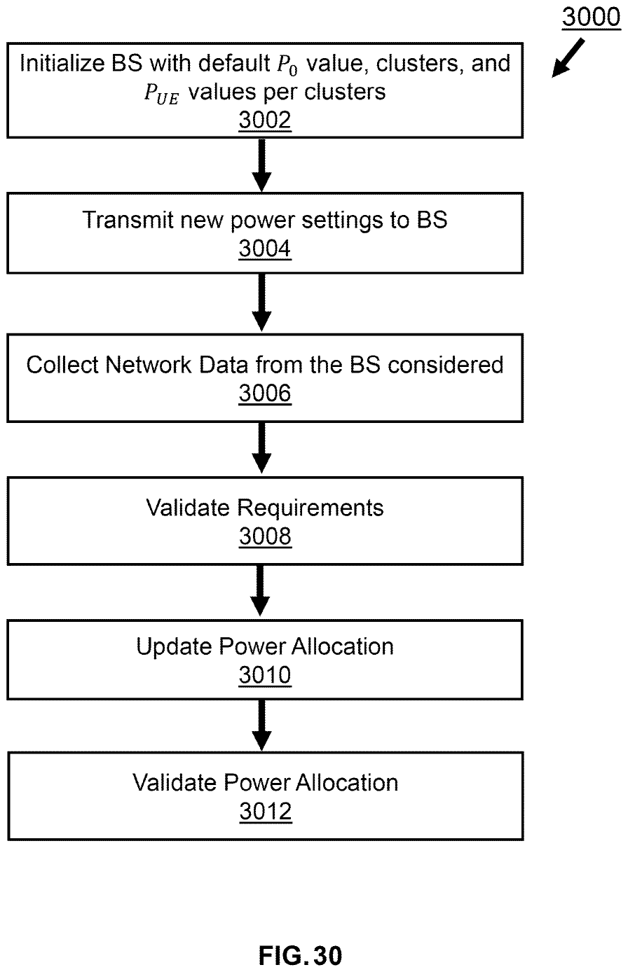

FIG. 30 illustrates some embodiments of a process for wireless communication by a network for PUSCH power control. Referring to FIG. 30, process 3000 begins at processing block 3002 where processing logic initializes a BS with a default P_0 value, with clusters, and with P_UE values per clusters. Process 3000 continues at processing block 3004 where processing logic transmits new power settings to BS and then at processing block 3006 processing logic collects network data from the BS. Process 3000 continues at processing block 3008 where processing logic validates requirements. Process 3000 continues at processing block 3010 where processing logic updates power allocation and then continues to processing block 3012 where processing logic validates the power allocation.

Although the techniques disclosed herein are shown for single antenna UEs and single antenna BS, they can also be applied with appropriate modifications in MIMO settings. One simple approach would convert the MIMO target SINR requirements to single antenna (SISO) scenario and directly apply the techniques specified here in that context as well. Another more attractive option directly considers the impact of multi-antenna array for reception at the base-station. In this case, in some embodiments, the multiple signals received across the array can be linearly combined to a single signal that has higher SINR than the signal at each individual antenna element. These are methods that are well known in the art. The disclosed techniques can be directly then applied at the output of the linear combiner.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present disclosure also relates to an apparatus for performing the operations described herein. This apparatus may be specifically constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; et cetera.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present disclosure is not described with reference to any particular programming language. It will be appreciated that a variety of programming languages may be used to implement the teachings of the disclosure as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary embodiments of the present disclosure. One skilled in the art will readily recognize from such discussion, the accompanying drawings and the claims that various modifications can be made without departing from the spirit and scope of the disclosure.

1. A method of wireless communication by a network for physical uplink shared channel (PUSCH) power control, the method comprising:
performing a power control algorithm for a plurality of iterations until a signal-to-interference-plus-noise ratio (SINR) is within a tolerance level of a target SINR, wherein each iteration includes, for each cell of a set of one or more cells,
obtaining the SINR associated with user equipments (UEs) in said each cell,
lowering transmit power of the UEs in said each cell upon determining SINR is above a target SINR, and
increasing transmit power upon determining SINR is below the target SINR; and
updating a power allocation among UEs in said each cell.

2. The method of claim 1, wherein the UEs in each cell are split in clusters and the power control algorithm is performed for each cluster of UEs in each cell.

3. The method of claim 1, further comprising:
initializing a first base station (BS) with default cluster groups and power values per cluster;
transmitting new power settings to the first BS; and
collecting network data from the first BS.

4. The method of claim 3, wherein the power values comprise P_0 and P_UE, wherein
P_0 is a predetermined power parameter for all UEs served by the first BS, and
P_UE is a power parameter of the specific UE.

5. The method of claim 3, wherein initializing cluster groups and their power values of the first BS comprises:
obtaining historical data for the first BS;
determining that historical data for the first BS that have the same day, time, or type of special event is available; and
obtaining initial power values and cluster groups based on the historical data for the first BS that have the same day, time, or type of special event.

6. The method of claim 3, wherein initializing the power values and cluster groups of the first BS comprises:
obtaining historical data for the first BS;
determining that historical data for the first BS that have the same day, time, or type of special event is not available;
initializing a P_0 value to a default value;
initializing a P_UE value to 0 for all UEs; and
initializing cluster groups as all combinations of a serving cell Reference Signal Received Power (RSRP) (servRSRP) and a neighbor cell RSRP (neigRSRP) in ranges.

7. The method of claim 6, wherein initializing cluster groups comprises:
setting a default range for servRSRP and a default range for neigRSRP as fixed limited ranges;
setting a default range for servRSRP and a default range for neigRSRP as the entire possible reported values for RSRP; or
setting initial cluster groups as a single cluster.

8. The method of claim 3, further comprising validating requirements for a cluster in the first BS or the neighboring BSs by:
receiving a historical measurement report (MR) for the first BS;
receiving a historical MR for neighboring BSs;
for all MR of the neighboring BSs showing the first BS as a neighboring BS and all MR of the first BS showing the neighboring BS as a neighboring BS, calculating a limit per cluster (Limit(A_C,˜A)) in the first BS;
calculating an average limit across all values in a cluster in the first BS or the neighboring BSs;
determining if an average SINR from data for the cluster is between the average limit and a lowest requirement;
setting a highest requirement as a value lower than the average limit; and
setting the lowest requirement as a value lower than the highest requirement.

9. The method of claim 8, wherein validating the requirements further comprises:
determining that the average SINR from data for the cluster is above the average limit or below the lowest requirement for the cluster; and
evaluating whether to break the cluster into two or more groups.

10. The method of claim 8, wherein the MR comprises servRSRP, neigRSRP, signal power minus interference and noise power (SINR), and the power values.

11. The method of claim 8, wherein the limit per cluster (Limit(A_C,˜A)) is based on RSRP values associated with at least one neighbor cell and a serving cell and at UE in a cluster of the first BS and a UE in the neighbor BS.

12. The method of claim 8, wherein the limit per cluster (Limit(A_C,˜A)) is calculated based on a formula:
Limit(A_C,˜A)=Σ(|neigRSRP_(A_C→˜A)−servRSRP_(A_C)+|neigRSRP_(˜A→A)−servRSRP_(˜A)|), wherein
neigRSRP_(A_C→˜A) is a neighbor RSRP value from a UE in cluster C of the first BS to the neighboring BS,
servRSRP_(A_C) is a serving RSRP value from a UE in cluster C of the first BS to the first BS,
neigRSRP_(˜A→A) is a neighbor RSRP value from a UE in the neighbor BS to the first BS, and
serving RSRP_(˜A) is a serving RSRP value from a UE in the neighbor BS to the neighbor BS.

13. The method of claim 9, wherein evaluating whether to break the cluster into two or more groups comprises:
determining that the cluster is covering more than one unique servRSRP values, and splitting the cluster into two new clusters with distinct servRSRP values that are within the range of the servRSRP originally covered;
determining that the cluster is covering more than one unique neigRSRP values, and splitting cluster into two new clusters with distinct neigRSRP values that are within the range of the neigRSRP values originally covered; or
determining that additional data for differentiating UEs within the cluster is available, splitting the cluster into two or more new clusters based on the additional data values.

14. The method of claim 12, wherein the additional data values comprise:
an RSRP value of a next strongest neighbor BS;
s_TMSI value of the UEs; or
latitude and longitude data of the UEs; or a unique identifier number for the UE.

15. The method of claim 9, wherein, upon evaluating whether to break a cluster into two or more groups,
determining that the cluster is not covering more than one unique servRSRP values or more than one unique neigRSRP values, and that additional data for differentiating UEs within the cluster is not available, and
improving measurements or data collection from the cluster.

16. The method of claim 3, wherein updating the power allocation comprises:
receiving historical measurement report (MR) for a BS;
if an SINR for a cluster of the BS is above the highest requirement, updating UE transmit power for the cluster according to the following formula:
updated P_(C,A)=present P_(C,A)−(SINR_C−highest requirement);
if the SINR for the cluster is below the lowest requirement, updating UE transmit power for the cluster according to the following formula:
updated P_(C,A)=present P_(C,A)+(lowest requirement−SINR_C); and
if the SINR for the cluster is between the lowest requirement and the highest requirement, maintaining present UE transmit power for the cluster.

17. The method of claim 16, further comprising:
rounding the UE transmit power for the cluster to the nearest integer value.

18. An apparatus comprising one or more processors configured to perform operations comprising:
perform a power control algorithm for a plurality of iterations until a signal-to-interference-plus-noise ratio (SINR) is within a tolerance level of a target SINR, wherein each iteration includes, for each cell in a set of one or more cells,
obtaining the SINR associated with user equipments (UEs) in said each cell,
lowering transmit power of the UEs in said each cell upon determining SINR is above a target SINR, and
increasing transmit power upon determining SINR is below the target SINR; and
updating a power allocation among UEs in said each cell.

19. The apparatus of claim 18, wherein updating the power allocation comprises:
receiving historical measurement report (MR) for a BS;
if an SINR for a cluster of the BS is above the highest requirement, updating power for the cluster according to the following formula:
$$updated P\_ ( C , A ) = present P\_ ( C , A ) - ( SINR\_C - highest requirement ) ;$$
if the SINR for the cluster is below the lowest requirement, updating power for the cluster according to the following formula:
updated P_(C,A)=present P_(C,A)+(lowest requirement−SINR_C); and
if the SINR for the cluster is between the lowest requirement and the highest requirement, maintaining present power for the cluster.

20. A non-transitory machine-readable medium having executable instructions to cause one or more processing units to perform a method comprising:
perform a power control algorithm for a plurality of iterations until a signal-to-interference-plus-noise ratio (SINR) is within a tolerance level of a target SINR, wherein each iteration includes, for each cell in a set of one or more cells,
obtaining the SINR associated with user equipments (UEs) in said each cell,
lowering transmit power of the UEs in said each cell upon determining SINR is above a target SINR, and
increasing transmit power upon determining SINR is below the target SINR; and
updating a power allocation among UEs in said each cell.
